(19) United States
(12) Patent Application Publication
(10) Pub. No.: US 2012/0196734 A1
(43) Pub. Date: Aug. 2, 2012

(54) FOLDING DEVICE AND FOLDING METHOD

(75) Inventors: Yoshimasa Endo, Otsu-shi (JP); Hiroshi Kitagawa, Otsu-shi (JP)

(73) Assignee: SEVEN DREAMERS LABORATORIES, INC., Redwood Shores, CA (US)

(21) Appl. No.: 13/502,514

(22) PCT Filed: Oct. 15, 2010
(86) PCT No.: PCT/JP2010/006135

§ 371 Date: Apr. 17, 2012

(30) Foreign Application Priority Data
Oct. 19, 2009 (JP) 2009-239985

(51) Int. Cl. B31B 1/26

(52) U.S. Cl. 493/405

(57) ABSTRACT

A folding device is provided that includes a platen member, a folding member, a folding member mechanism and a horizontal side moving mechanism. A folding object is put on the platen member while an extended part thereof is extended from at least one of right and left sides of the platen member. The folding member mechanism moves the folding member towards the platen member for folding the extended part of the folding object. The horizontal slide moving mechanism slides and moves at least one of the platen member and the folding member for separating the platen member and the folding member along a horizontal direction.

### TECHNICAL HELD

The present invention relates to a folding device for and a folding method of folding a flexible object such as clothing.

### BACKGROUND ART

A variety of “folding devices for automatically folding a fabric product such as a shirt” have been proposed so far.

Depending on folding methods, the folding devices are roughly classified into slide type folding devices (see Japan Laid-open Patent Application Publication Nos. JP-A-H08-215500, JP-A-1108-215499, JP-A-1108-215498, JP-A-1108-215497, JP-A-2008-18100, JP-A-2000-202200 and JP-A-H05-294552, etc.), a flip-up-to-the-bottom type folding device (see Japan Laid-open Patent Application Publication Nos. JP-A-H06-304399 and JP-A-H10-218485, etc.), a flip-up-to-the-top type folding device (see Publication of Japanese Translation of PCT International Application No. JP-A-2003-432451, Japan Laid-open Patent Application Publication Nos. JP-A-H07-61703, JP-A-2008-264316, JP-A-2003-181200 and JP-A-2002-119800, etc.) and a rotary type folding device (see brochure of PCT International Application Publication No. WO2008/032826, etc.).

### CITATION LIST

### Patent Literature

PTL1: Japan Laid-open Patent Application Publication No. JP-A-H08-215497
PTL2: Japan Laid-open Patent Application Publication No. JP-A-H08-215498
PTL3: Japan Laid-open Patent Application Publication No. JP-A-H08-215499
PTL4: Japan Laid-open Patent Application Publication No. JP-A-H08-215500
PTL5: Japan Laid-open Patent Application Publication No. JP-A-2008-18100
PTL6: Japan Laid-open Patent Application Publication No. JP-A-2000-202200
PTL7: Japan Laid-open Patent Application Publication No. JP-A-H05-294552
PTL8: Brochure of PCT International Application Publication No. WO2008/032826
PTL9: Japan Laid-open Patent Application Publication No. JP-A-H06-304399
PTL10: Japan Laid-open Patent Application Publication No. JP-A-H10-218485
PTL11: Publication of Japanese Translation of PCT International Application No. JP-A-2003-432451
PTL12: Japan Laid-open Patent Application Publication No. JP-A-H07-61703
PTL13: Japan Laid-open Patent Application Publication No. JP-A-2002-119800
PTL14: Japan Laid-open Patent Application Publication No. JP-A-2003-181200
PTL15: Japan Laid-open Patent Application Publication No. JP-A-2008-264316

### SUMMARY OF THE INVENTION

### Technical Problem

A fabric product is partially pulled in the slide type folding device during execution of a folding action. Therefore, a fabric product may be damaged by the slide type folding device during execution of a folding action.

Unlike the slide type folding device, by contrast, a fabric product is not partially pulled in each of the flip-up-to-the-bottom type folding device, the flip-up-to-the-top type folding device and the rotary type folding device during execution of a folding action. Therefore, chances are extremely low that a fabric product is damaged by any of these types of folding devices during execution of a folding action.

However, in the flip-up-to-the-bottom type folding device, the flip-up-to-the-top type folding device and the rotary type folding device, a folding plate cannot be pulled out from a fabric product without losing the folded shape of the fabric product, unlike the slide type folding device configured to simply move the folding plate in the opposite direction after completion of a folding action. In these types of folding devices, a folded fabric product may get stuck with the folding plate when being pulled out from the folding plate after completion of a folding action. The fabric product may be thereby damaged.

It is an object of the present invention to take out a folded fabric product with little chances of damaging the fabric product after completion of a folding action in a type of folding device hardly damaging the fabric product in performing the folding action such as a flip-up-to-the-bottom type folding device, a flip-up-to-the-top type folding device or a rotary type folding device.

### Solution to Problem

A folding device according to a first aspect of the present invention includes a platen member, a folding member(s), a folding mechanism and a horizontal slide moving mechanism. The platen member is configured to be put a folding object thereon for allowing a part of the folding object to be extended from at least either of right and left sides thereof. The number of the folding members is at least one. The folding mechanism is configured to move the folding member towards the platen member for folding the extended part of the folding object. It should be noted that examples of the folding mechanism include a rotary type folding mechanism as described in the brochure of PCT International Application Publication No. WO2008/032826, a flip-up-to-the-bottom type folding mechanism as described in Japan Laid-open Patent Application Publication No. JP-A-H06-304399 and JP-A-H10-218485, and a flip-up-to-the-top type folding device as described in Publication of Japanese Translation of PCT International Application No. JP-A-2003-432451 and Japan Laid-open Patent Application Publication Nos. JP-A-H07-61703, JP-A-2008-264316, JP-A-2003-181200 and JP-A-2002-119800. It should be also noted that a slide type folding mechanism, as described in Japan Laid-open Patent Application Publication Nos. JP-A-H08-215500, JP-A-H08-215499, JP-A-H08-215498, JP-A-H08-215497, JP-A-2008-18100, JP-A-2000-202200 and JP-A-H05-294552, are excluded from examples of the folding mechanism according to the first aspect of the present invention. The reason for excluding the slide type folding mechanism is that a folding member provided therein is configured to be moved towards either a space above or below a platen member not towards the platen member. The horizontal slide moving mechanism of the present folding device is configured to slide and move at least either of the platen member and the folding member at least either rightward or leftward for separating the platen member and the folding member along a horizontal direction. It should be noted that the horizontal slide moving mechanism is provided separately from the folding mechanism. Further, the folding member (or members) is normally disposed on both side of the platen member. In this case, the horizontal slide moving mechanism may be configured as follows. (1) While the platen member is fixed, the horizontal slide moving mechanism may be configured to slide and move two folding members rightward and leftward for separating the folding members away from the platen member. (2) While one of the folding members is fixed (hereinafter referred to as “a stationary folding member”), the horizontal slide moving mechanism may be configured to slide and move the platen member and the other of the folding members (hereinafter referred to as “a movable folding member”) rightward or leftward for separating the movable folding member away from the platen member and simultaneously for separating the platen member away from the stationary folding member.

According to the folding device of the first aspect of the present invention, a part of the folding object, which is extended from the platen member, is folded by the folding mechanism. It should be noted that the folding mechanism is herein configured to move the folding member towards the platen member. Therefore, the folding device hardly damages a fabric product in performing a folding action for the fabric product. Then, the folding device is configured to slide and move at least either of the platen member and the folding member at least either rightward or leftward for horizontally separating the platen member and the folding member by means of the horizontal slide moving mechanism after the folding object is folded. As a result, the folding member is removed out of the folding object. It should be herein noted that the folding member is obviously slid and moved towards a side where no part of the folding object exists. Therefore, the folding device can take out the folding object (e.g., a fabric product) in a folded state with little chances of damaging the folding object after completion of the folding action.

Consequently, the folding device can take out the folding object (e.g., a fabric product) in a folded state with little chances of damaging the folding object not only during performance of the folding action but also after completion of the folding action.

A folding device according to a second aspect of the present invention relates to the folding device according to one of the first and second aspects of the present invention. In the folding device, the platen member is formed by a pair of first members opposed to each other. Further, the folding device further includes a width adjusting mechanism. The width adjusting mechanism is configured to dispose the first members either closer to each other or away from each other.

In the folding device, the tension applied to the folding object by the platen member is relieved and the folding object can be thereby easily pulled out when the width adjusting mechanism is caused to reduce the width of the platen member (i.e., the width adjusting mechanism is caused to dispose the first members closer to each other) after completion of the folding action. According to the folding device of the second aspect of the present invention, it is possible to prevent the folding object from getting stuck with the platen member and thereby being damaged.

A folding device according to a third aspect of the present invention relates to the folding device according to one of the first and second aspects of the present invention. In the folding device, the platen member is allowed to be put the folding object thereon for allowing a part of the folding object to be hung down from at least either of the right and left sides thereof in an initial state. The folding member is disposed below the platen member in the initial state. The folding mechanism includes a second moving mechanism and a rotary mechanism. The second moving mechanism is configured to either slide and move or rotate and move the folding member towards the platen member. The rotary mechanism is configured to rotate the platen member and the second moving mechanism in right and left directions. In short, the folding device is a rotary type folding device. It should be noted that the rotary mechanism may include a platen member rotary mechanism for rotating the platen member and a second moving mechanism rotary mechanism for rotating a second moving mechanism.

It should be also noted in the folding device that the folding object is put on the platen member while a part thereof is hung down from at least either of the right and left sides of the platen member in the initial state. Next, the rotary mechanism is configured to rotate the platen member and the second moving mechanism towards the side where a part of the folding object is hung down so that the opposed direction of the platen member and the folding member intersects with the vertical direction. It should be herein noted that a part of the folding object is positioned in the vicinity of the back face opposite to the platen face of the platen member. The slide moving member is then configured to be either slid and moved or rotated and moved towards the platen member so that a part of the folding object is interposed therebetween.

A folding device according to a fourth aspect of the present invention relates to the folding device according to one of the first and second aspects of the present invention. In the folding device, the platen member is allowed to be put the folding object thereon for allowing a part of the folding object to be hung down from at least either of the right and left sides thereof in an initial state. The folding mechanism is configured to rotate the folding member to the downward of the platen member from at least either of right and left sides. In short, the folding device is a flip-up-to-the-bottom type folding device.

It should be noted in the folding device that the folding object is put on the platen member while a part thereof is hung down on at least either of the right and left sides in the initial state. Next, the folding mechanism is configured to rotate the folding member to the downward of the platen member (i.e., to the opposite side to the folding-object disposed side) from either of the right and left sides. Accordingly, a part of the folding object is interposed and held between the platen member and the folding member.

A folding device according to a fifth aspect of the present invention relates to the folding device according to one of the first and second aspects of the present invention. In the folding device, the folding mechanism is configured to rotate the folding member to the upward of the platen member from at least either of right and left sides. In other words, the folding device is a flip-up-to-the-top type folding device.

It should be noted in the folding device that the folding object is put on the platen member while a part thereof is extended from at least either of the right and left sides in the initial state. Next, the folding mechanism is configured to rotate the folding member to the upward of the platen member (i.e., to the folding-object disposed side) from at least either of the right and left sides. Accordingly, a part of the folding object is interposed and held between the platen member and the folding member.

A folding method according to a sixth aspect of the present invention includes a first step, a second step and a third step. In the first step, a folding object is put on a platen member for allowing a part of the folding object to be extended from at least either of right and left sides of the platen member. In the second step, a folding member is moved towards the platen member for folding the extended part of the folding object. In the third step, at least either of the platen member and the folding member is slid and moved to at least either rightward or leftward for separating the platen member and the folding member along a horizontal direction in order to pull the folding member out of the folding object in a folded state. It should be noted that the folding members are normally disposed on the both sides of the platen member. In this case, the folding members may be configured as follows. (1) While the platen member is fixed, the folding members may be configured to be slid and moved rightward and leftward for separating the folding members away from the platen member. (2) While one of the folding members is fixed (hereinafter referred to as “a stationary folding member”), the platen member and the other of the folding members (hereinafter referred to as “a movable folding member”) may be configured to be slid and moved either rightward or leftward for separating the movable folding member away from the platen member and simultaneously for separating the platen member away from the stationary folding member.

In the folding method, the folding object is firstly put on the platen member while a part thereof is extended from either of the right and left sides of the platen member (the first step). Next, the folding member is moved towards the platen member and the extended part of the folding object is folded (the second step). In the folding method, a fabric product is thus hardly damaged in performing a folding action. Subsequently, at least either of the platen member and the folding member is slid and moved at least either rightward or leftward for horizontally separating the platen plate and the folding member away from each other. Accordingly, the folding member is pulled out of the folding object in a folded state (the third step). It should be herein noted that the folding member is obviously slid and moved to the side where no part of the folding object exists. In the folding method, the folding object (e.g., a fabric product) in a folded state can be pulled out with little chances of damage after completion of the folding action.

According to the folding method of the sixth aspect of the present invention, the folding object (e.g., a fabric product) in a folded state can be taken out with little chances of damage not only during execution of the folding action but also after completion of the folding action.

A folding method according to a seventh aspect of the present invention relates to the folding method according to the sixth aspect of the present invention. The folding method further includes a fourth step. It should be noted that the fourth step is configured to be executed between the second step and the third step. In the fourth step, the folding member is configured to be returned to be separated away from the platen member along a direction perpendicular to the horizontal direction. In other words, the folding member, moved towards the platen member in the second step, is moved to the opposite direction in the fourth step. It should be noted that the displacement amount of the folded member in the opposite direction is preferably set for sufficiently reducing frictional force of the folding member with respect to the folding object, and simultaneously, for easily pulling the folding plate out of the folding object.

According to the folding method of the seventh aspect of the present invention, it is possible to easily pull the folding member out of the folding object and avoid a situation of applying excessive friction to the folding object.

A folding method according to an eighth aspect of the present invention relates to the folding method according to the sixth aspect of the present invention. In the folding method, the platen member is formed by a pair of first members opposed to each other. The folding method further includes a fifth step. It should be noted that the fifth step is configured to be executed either simultaneously with the third step or after the third step or between the second step and the third step. In the fifth step, the first members are disposed closer to each other.

Tension acting on the folding object by the platen member is thereby relieved and the folding object can be easily pulled out. According to the folding method of the eighth aspect of the present invention, it is thus possible to prevent the folding object from getting stuck with the platen member and being thereby damaged.

### BRIEF DESCRIPTION OF THE DRAWINGS

FIG. 1 is a side view of a folding device according to a first exemplary embodiment of the present invention.

FIG. 2 is a front view of the folding device according to the first exemplary embodiment of the present invention.

FIG. 3 is a plan view of the folding device according to the first exemplary embodiment of the present invention.

FIG. 4 is an enlarged side view of a folding mechanism of the folding device according to the first exemplary embodiment of the present invention.

FIG. 5 is an enlarged front view of the folding mechanism of the folding device according to the first exemplary embodiment of the present invention.

FIG. 6 is an enlarged plan view of the folding mechanism of the folding device according to the first exemplary embodiment of the present invention.

FIG. 7 is an enlarged rear view of the folding mechanism of the folding device according to the first exemplary embodiment of the present invention.

FIG. 8 is a front view of the folding mechanism, set to be in an initial state of the folding device according to the first exemplary embodiment of the present invention.

FIG. 9 is a front view of the folding mechanism, set to be in a second state, of the folding device according to the first exemplary embodiment of the present invention.

FIG. 10 is a front view of the folding mechanism, set to be in a third state, of the folding device according to the first exemplary embodiment of the present invention.

FIG. 11 is a front view of the folding mechanism, set to be in a fourth state, of the folding device according to the first exemplary embodiment of the present invention.

FIG. 12 is a front view of the folding mechanism, set to be in a fifth state, of the folding device according to the first exemplary embodiment of the present invention.

FIG. 13 is a front view of the folding mechanism, set to be in a sixth state, of the folding device according to the first exemplary embodiment of the present invention.

FIG. 14 is a front view of the folding mechanism, set to be in a seventh state, of the folding device according to the first exemplary embodiment of the present invention.

FIG. 15 is a front view of the folding mechanism, set to be in an eighth state, of the folding device according to the first exemplary embodiment of the present invention.

FIG. 16 is a front view of the folding mechanism, set to be in a ninth state, of the folding device according to the first exemplary embodiment of the present invention.

FIG. 17 is a front view of the folding mechanism, set to be in a tenth state, of the folding device according to the first exemplary embodiment of the present invention.

FIG. 18 is a front view of the folding mechanism, set to be in an eleventh state, of the folding device according to the first exemplary embodiment of the present invention.

FIG. 19 is a side view of a transporting mechanism, set to be in a second state, of the folding device according to the first exemplary embodiment of the present invention.

FIG. 20 is a side view of the transporting mechanism, set to be in a third state, of the folding device according to the first exemplary embodiment of the present invention.

FIG. 21 is a side view of the transporting mechanism, set to be in a fourth state, of the folding device according to the first exemplary embodiment of the present invention.

FIG. 22 is a simplified front view of a state of a folding object when the folding mechanism of the folding device according to the first exemplary embodiment of the present invention is set to be in the initial state.

FIG. 23 is a simplified front view of a state of a folding object that a hung down portion thereof does not reach a position of a contact bar portion when the folding mechanism of the folding device of the first exemplary embodiment of the present invention is set to be in the second state.

FIG. 24 is a simplified front view of a state of the folding object partially dropped into a space between platen plates and a first folding plate when the folding mechanism of the folding device according to the first exemplary embodiment of the present invention is set to be in the second state.

FIG. 25 is a simplified front view of a state of a folding object that the hung down portion thereof exceeds the position of the contact bar portion when the folding mechanism of the folding device according to the first exemplary embodiment of the present invention is set to be in the second state.

FIG. 26 is a side view of a folding device according to a second exemplary embodiment of the present invention.

FIG. 27 is a front view of the folding device according to the second exemplary embodiment of the present invention.

FIG. 28 is a plan view of the folding device according to the second exemplary embodiment of the present invention

FIG. 29 is a front view of a folding mechanism, set to be in a second state, of the folding device according to the second exemplary embodiment of the present invention.

FIG. 30 is a front view of the folding mechanism, set to be in a third state, of the folding device according to the second exemplary embodiment of the present invention.

FIG. 31 is a front view of the folding mechanism, set to be in a fourth state, of the folding device according to the second exemplary embodiment of the present invention.

FIG. 32 is a front view of the folding mechanism, set to be in a fifth state, of the folding device according to the second exemplary embodiment of the present invention.

FIG. 33 is a side view of a transporting mechanism, set to be in a second state, of the folding device according to the second exemplary embodiment of the present invention.

FIG. 34 is a side view of the transporting mechanism, set to be in a third state, of the folding device according to the second exemplary embodiment of the present invention 1.

FIG. 35 is a side view of the transporting mechanism, set to be in a fourth state, of the folding device according to the second exemplary embodiment of the present invention.

FIG. 36 is a side view of the folding mechanism, set to be in a sixth state, of the folding device according to the second exemplary embodiment of the present invention.

### REFERENCE SIGNS LIST

100, 400 Folding device
201, 501 Platen plate (Platen member)
211, 212, 213, 214, 511, 512, 513, 514 Folding plate (Slide moving member)
260 Second folding plate sliding mechanism (Horizontal slide moving mechanism)
540 Folding plate sliding mechanism (Horizontal slide moving mechanism)
CL1, CL2 Folding object
Dh Horizontal direction

### DESCRIPTION OF THE EMBODIMENTS

### First Exemplary Embodiment

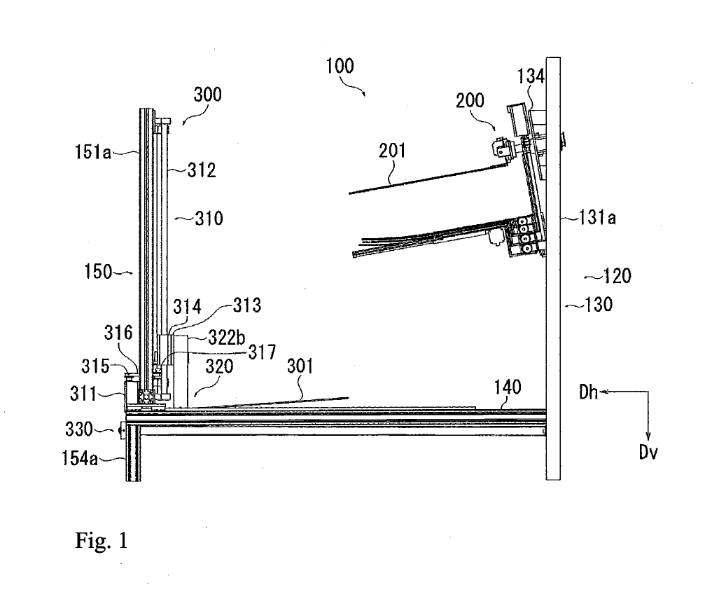

As illustrated in FIGS. 1 to 3, a folding device 100 according to a first exemplary embodiment of the present invention mainly includes a frame 120, a folding mechanism 200 and a transporting mechanism 300.

Elements of the folding device 100 will be hereinafter respectively described in detail.

<Structure of Folding Device>

(1) Frame

As illustrated in FIGS. 1 to 3, the frame 120 is mainly formed by a front frame 130, side frames 140 and a rear frame 150.

Elements of the frame 120 will be hereinafter respectively described in detail.

(1-1) Front Frame

As illustrated in FIGS. 1 to 3, the front frame 130 is mainly formed by two first pillar members 131a and 131b, two first upper beam members 132a and 132b, a first lower beam member 133 and a first plate member 134.

The first pillar members 131a and 131b are disposed while the axes thereof are arranged along a vertical direction Dv.

The first upper beam members 132a and 132b are extended between the upper parts of the first pillar members 131 and 131b in a horizontal direction Dh in order to connect the upper parts of the first pillar members 131a and 131b.

The first lower beam member 133 is extended between the lower parts of the first pillar members 131a and 131b in the horizontal direction Dh in order to connect the lower parts of the first pillar members 131a and 131b.

The first plate member 134 is fixed to the first upper beam members 132a and 132b while the plate face thereof is disposed along the vertical direction Dv. It should be noted that the folding mechanism 200 is rotatably fixed to the first plate member 134.

(1-2) Side Frames

As illustrated in FIGS. 1 to 3, the side frames 140 are two beam members, each of which connects a lower part of the front frame 130 and that of the rear frame 150.

(1-3) Rear Frame

As illustrated in FIGS. 1 to 3, the rear frame 150 is mainly formed by two second pillar members 151a and 151b, a second upper beam member 152, a second lower beam member 153 and two leg members 154a and 154b. It should be noted that the transporting mechanism 300 is attached to the rear frame 150.

The second pillar members 151a and 151b are disposed while the axes thereof are arranged along the vertical direction Dv.

The second upper beam member 152 is extended between the second pillar members 151a and 151b in the horizontal direction Dh in order to couple the top ends of the second pillar members 151a and 151b.

The second lower beam member 153 is extended under the second pillar members 151a and 151b in the horizontal direction Dh in order to couple the bottom ends of the second pillar members 151a and 151b.

The leg members 154a and 154b are downwardly extended from the both ends of the second lower beam member 153. The leg members 154a and 154b serve to keep a roughly horizontal position of the folding device 100 together with the first pillar members 131a and 131b.

(2) Folding Mechanism

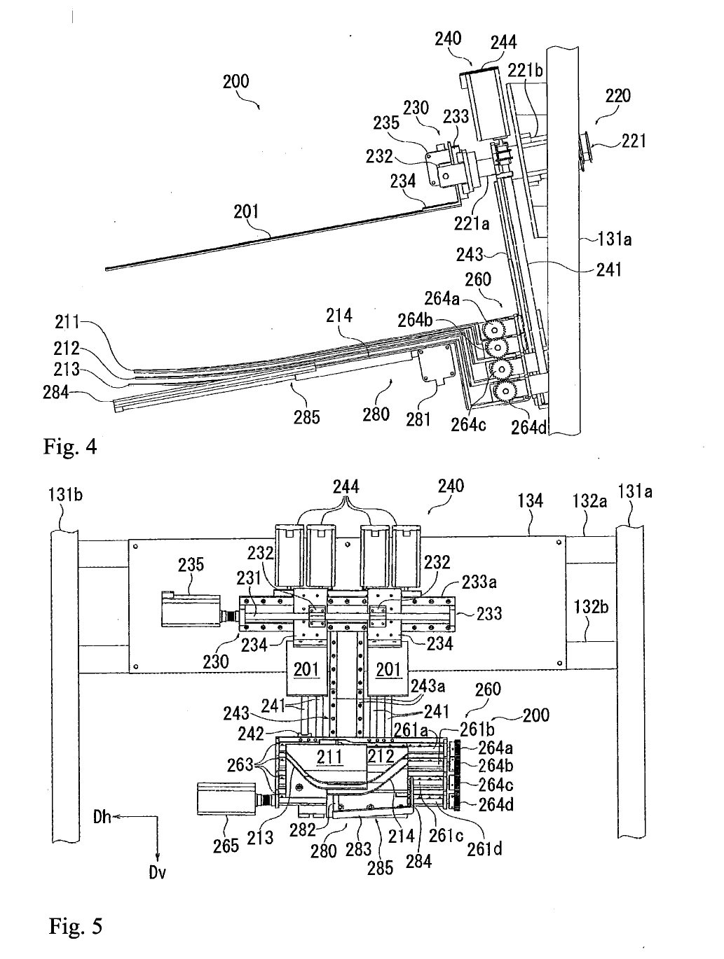

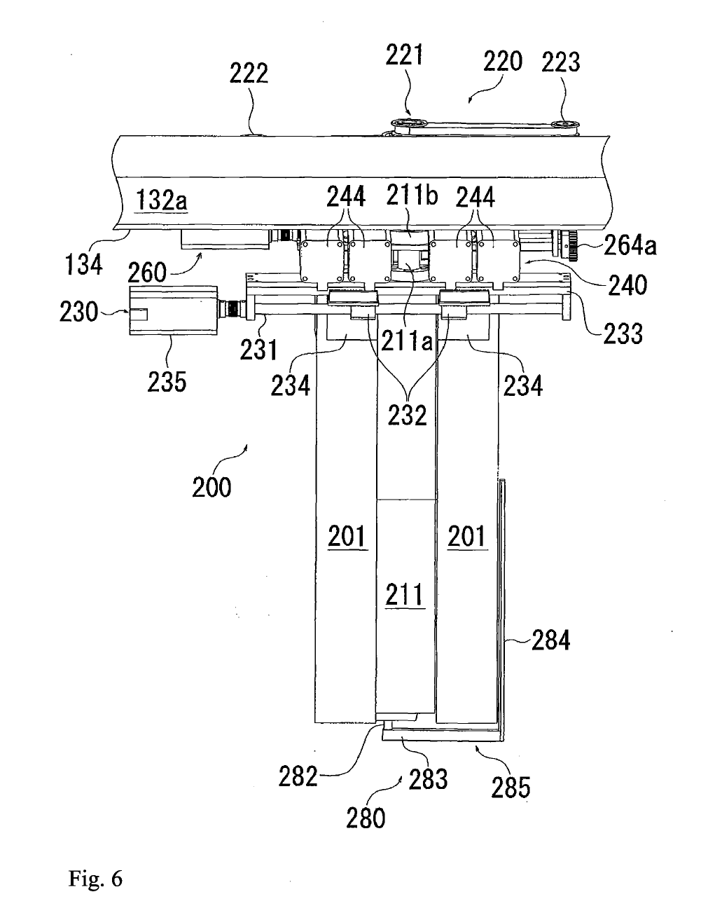

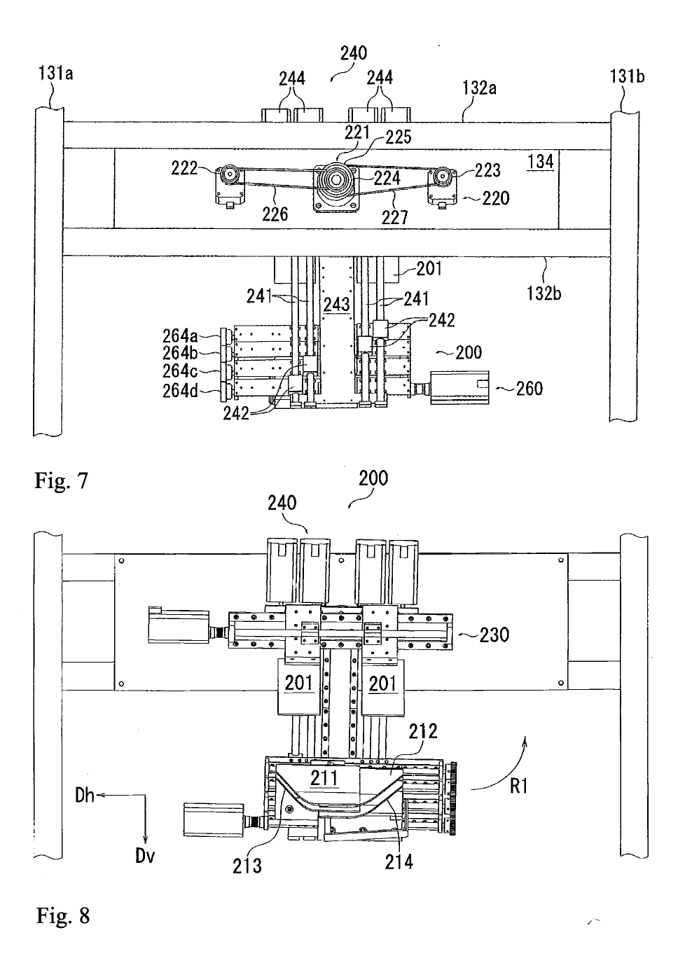

As described above, the folding mechanism 200 is rotatably fixed to the first plate member 134 of the front frame 130. As illustrated in FIGS. 4 to 7, the folding mechanism 200 mainly includes a pair of platen plates 201, four folding plates 211 to 214, a dual nested shaft rotary mechanism 220, an inter-platen-plate distance adjusting mechanism 230, a first folding plate sliding mechanism 240, a second folding plate sliding mechanism 260 and a rotary bar mechanism 280. It should be noted that the folding plates with reference numerals of 211, 212, 213 and 214 may be hereinafter referred to as “a first folding plate”, “a second folding plate”, “a third folding plate” and “a fourth folding plate”.

Elements of the folding mechanism 200 will be hereinafter respectively explained in detail.

(2-1) Platen Plates

The platen plates 201 are a pair of roughly rectangular plate members. As illustrated in FIG. 1, each platen plate 201 is downwardly slanted towards the tip thereof. In an initial state, a folding object (e.g., clothing) is put on the platen plates 201.

Further, the distance between the platen plates 201 is adjusted by the inter-platen-plate distance adjusting mechanism 230. It should be noted that the distance between the platen plates 201 is adjusted in accordance with the clothing size and/or the like.

It should be noted that the tips of the platen plates 201 may be further protruded towards the rear frame than those of the folding plates 211 to 214 in a side view.

(2-2) Folding Plates

The folding plates 211 to 214 are members for serving to fold a folding object put on the platen plates 201. Each of the folding plates 211 to 214 has a roughly right-angled trapezoidal shape in a plan view. As illustrated in FIG. 4, the folding plates 211 to 214 are disposed below and opposed to the platen plates 201 at a predetermined interval in an initial state.

In the present exemplary embodiment, each of the first, second and third folding plates 211, 212 and 213 is upwardly bent towards the tip thereof. By contrast, the fourth folding plate 214 is downwardly slanted towards the tip thereof, similarly to the platen plates 201.

Further in the present exemplary embodiment, each of the first and third folding plates 211 and 213 is aligned to the left in FIG. 5 while the hypotenuse thereof is positioned on the left side. On the other hand, each of the second and fourth folding plates 212 and 214 is aligned to the right in FIG. 5 while the hypotenuse thereof is positioned on the right side.

(2-3) Dual Nested Shaft Rotary Mechanism

As illustrated in FIGS. 4, 6, 7 and 8, the dual nested shaft rotary mechanism 220 mainly includes a dual nested shaft 221, a platen plate rotary motor 222, a folding plate rotary motor 223, an inner shaft pulley 224, an outer shaft pulley 225, a first pulley belt 226 and a second pulley belt 227.

The dual nested shaft 221 is formed by an inner shaft 221a and an outer shaft 221b. It should be noted that the inner shaft 221a is a columnar shaft, while the outer shaft 221b is a cylindrical shaft. The inner shaft 221a is rotatably inserted into the outer shaft 221b while the both ends thereof are partially protruded from the outer shaft 221b.

The inner shaft pulley 224 is fitted onto the base end of the inner shaft 221a.

The outer shaft pulley 225 is fitted onto the base end of the outer shaft 221b.

The first pulley belt 226 is stretched over a shaft of the platen plate rotary motor 222 and the inner shaft pulley 224. The first pulley belt 226 serves to transfer rotary power of the platen plate rotary motor 222 to the inner shaft 221a for rotating the inner shaft 221a.

The second pulley belt 227 is stretched over a shaft of the folding plate rotary motor 223 and the outer shaft pulley 225. The second pulley belt 227 serves to transfer rotary power of the folding plate rotary motor to the outer shaft 221b for rotating the outer shaft 221b.

The platen plate rotary motor 222 and the folding plate rotary motor 223 are forwardly and reversely rotatable.

It should be noted in the present exemplary embodiment that the inner shaft 221a is coupled to the inter-platen-plate distance adjusting mechanism 230 while the outer shaft 221b is coupled to the first folding plate sliding mechanism 240. In other words, in the present exemplary embodiment, the inter-platen-plate distance adjusting mechanism 230 and the platen plates 201 are configured to be rotated in conjunction with rotation of the platen plate rotary motor 222. More accurately described, each platen plate 201 is configured to be rotated about a conceptual axis within the plate face thereof while being swiveled about the inner shaft 221a. On the other hand, in conjunction with rotation of the folding plate rotary motor 223, each of the folding plates 211 to 214 is configured to be rotated about a conceptual axis within the plate face thereof while the first folding plate sliding mechanism 240 and the folding plates 211 to 214 are configured to be swiveled about the outer shaft 221b.

In the present exemplary embodiment, the platen plates 201 and the folding plates 211 to 214 are further designed to be rotated without changing the opposed positional relation thereof.

(2-4) Inter-Platen-Plate Distance Adjusting Mechanism

As illustrated in FIGS. 4 to 6, the inter-platen-plate distance adjusting mechanism 230 mainly includes a first ball screw 231, first nuts 232, a first rail member 233, platen plate attaching members 234 and a first ball screw driving motor 235.

The first ball screw 231 is formed by a right-handed thread ball screw portion and a left-handed thread ball screw portion. It should be noted that the right-handed thread ball screw portion and the left-handed thread ball screw portion are disposed concentrically to each other. Further, the first ball screw 231 is rotatably fixed to the first rail member 233 while the axis thereof is arranged in parallel to a rail portion 233a of the first rail member 233.

The first nuts 232 are screwed onto the right-handed thread ball screw portion and the left-handed thread ball screw portion of the first ball screw 231, respectively. The first nuts 232 are configured to be slid and moved on the rail member 233 along the axial direction of the first ball screw 231 in conjunction with driving of the first ball screw driving motor 235. It should be noted in the present exemplary embodiment that the first nuts 232 are configured to be slid and moved in opposite directions due to the structure that the first nuts 232 are respectively screwed onto the right-handed thread ball screw portion and the left-handed thread ball screw portion of the first ball screw 231. In other words, the first nuts 232 are configured to be slid and moved closer to or away from each other.

The platen plate attaching members 234 serve to fix the platen plates 201 to the first nuts 232, respectively. Further, each platen plate attaching member 234 includes a rail engaging portion (not illustrated in the figures) on the back face thereof. The rail engaging portion is herein meshed with the rail portion 233a of the first rail member 233.

The first ball screw driving motor 235 is coupled to an end of the first ball screw 231 while the shaft thereof is arranged along the axis of the first ball screw 231.

(2-5) First Folding Plate Sliding Mechanism

As illustrated in FIGS. 4 to 7, the first folding plate sliding mechanism 240 mainly includes second ball screws 241, second nuts 242, a second rail member 243, second ball screw driving motors 244 and the second folding plate sliding mechanism 260. It should be noted that the first folding plate sliding mechanism 240 according to the present exemplary embodiment is provided with four sets of the aforementioned elements.

As illustrated in FIGS. 4 to 7, four second ball screws 241 are disposed in parallel to each other along a direction roughly perpendicular to the platen plates 201. In FIG. 5, two of the second ball screws 241 are disposed on the left side of the second rail member 243, while the remaining two of the second ball screws 241 are disposed on the right side of the second rail member 243. It should be noted that each second ball screw 241 is rotatably fixed to the second rail member 243 while the axis thereof is arranged in parallel to a rail portion 243a of the second rail member 243.

Four second nuts 242 are screwed onto four second ball screws 241, respectively. Each second nut 242 is configured to be slid and moved on the second rail member 243 along the axis direction of the corresponding second ball screw 241 by means of driving of the corresponding second ball screw driving motor 244.

The second folding plate sliding mechanism 260 is mechanically interposed between four second nuts 242 and four folding plates 211 to 214. The second folding plate sliding mechanism 260 serves to fix four folding plates 211 to 214 to four second nuts 242, respectively. Further, the second folding plate sliding mechanism 260 includes a rail engaging portion (not illustrated in the figures) on the back face thereof. The rail engaging portion is meshed with the rail portion 243a of the second rail member 243.

Each second ball screw driving motors 244 is coupled to the top end of the corresponding second ball screw 241 while the shaft thereof is arranged along the axis of the corresponding second ball screw 241.

(2-6) Second Folding Plate Sliding Mechanism

As illustrated in FIGS. 4 to 7, the second folding plate sliding mechanism 260 mainly includes third ball screws 261a to 261d, third nuts (not illustrated in the figures), third rail members 263, third gears 264a to 264d and a third ball screw driving motor 265. It should be noted that the second folding plate sliding mechanism 260 according to the present exemplary embodiment includes four sets of the aforementioned elements excluding the third ball screw driving motor 265. In the following explanation, the third ball screws with reference numerals of 261a, 261b, 261c and 261d may be respectively referred to as “a 31^{st} ball screw”, “a 32^{nd} ball screw”, “a 33^{rd} ball screw” and “a 34^{th} ball screw”. Further, the third gears with reference numerals of 264a, 264b, 264c and 264d may be respectively referred to as “a 31^{st} gear”, “a 32^{nd} gear” and “a 33^{rd} gear” and “a 34^{th} gear”.

As illustrated in FIG. 5, four third ball screws 261a to 261d are disposed in roughly parallel to the first ball screw 231.

Four third nuts are screwed onto four third ball screws 261a to 261d, respectively. Further, the folding plates 211 to 214 are attached to the third nuts, respectively. It should be noted that the fourth folding plate 214 is attached to one of the third nuts disposed farthest from the platen plates 201, while the third folding plate 213 is attached to one of the third nuts disposed second farthest from the platen plates 201. Further, the second folding plate 212 is attached to one of the third nuts disposed third farthest from the platen plates 201, while the first folding plate 211 is attached to one of the third nuts disposed closest to the platen plates 201.

When the 34^{th} ball screw 261d is rotated by means of the third ball screw driving motor 265 while all the third gears 264a to 264d are meshed with each other, the third nut screwed onto the 34^{th} ball screw 261d is configured to be slid and moved rightward in FIG. 5 on corresponding one of the third rail members 263 along the axial direction of the 34^{th} ball screw 261d. On the other hand, the third nut screwed onto the 33^{nd} ball screw 261b is configured to be slid and moved leftward in FIG. 5 on corresponding one of the third rail members 263 along the axial direction of the 33^{nd} ball screw 261b. Further, the third nut screwed onto the 32^{nd} ball screw 261b is configured to be slid and moved rightward in FIG. 5 on corresponding one of the third rail members 263 along the axial direction of the 32^{nd} ball screw 261b. Yet further, the third nut screwed onto the 31^{st} ball screw 261a is configured to be slid and moved leftward in FIG. 5 on corresponding one of the third rail members 263 along the axial direction of the 31^{st} ball screw 261a.

The third gears 264a to 264d are spur gears respectively attached to the ends of the third ball screws 261a to 261d, respectively, while the axes thereof are matched with the rotational axes of the third ball screws 261a to 261d, respectively. When the 34^{th} ball screw 261d is rotated by means of the third ball screw driving motor 265 while all the third gears 264a to 264d are meshed with each other, the 34^{th} gear 264d is rotated in the same direction as the rotational direction of the 34^{th} ball screw 261d while the 33^{rd} gear 264c is rotated in the reverse direction from the rotational direction of the 34^{th} ball screw 261d. Further, the 32^{nd} gear 264b is rotated in the same direction as the rotational direction of the 34^{th} ball screw 261d while the 31^{st} gear 264a is rotated in the reverse direction from the rotational direction of the 34^{th} ball screw 261d. The phenomenon enables slide movement of the aforementioned third nuts.

The third ball screw driving motor 265 is coupled to an end of the 34^{th} ball screw 261d while the shaft thereof is arranged along the axis of the 34^{th} ball screw 261d.

(2-7) Rotary Bar Mechanism 280

As illustrated in FIGS. 4-6 and 9, the rotary bar mechanism 280 mainly includes a bar rotary motor 281, a 41^{st} gear 286, a 42^{nd} gear (not illustrated in the figures) and a rotary bar 285.

The bar rotary motor 281, which is forwardly and reversely rotatable, is attached to the back face (not faced to the platen plates 201) of the fourth folding plate 214.

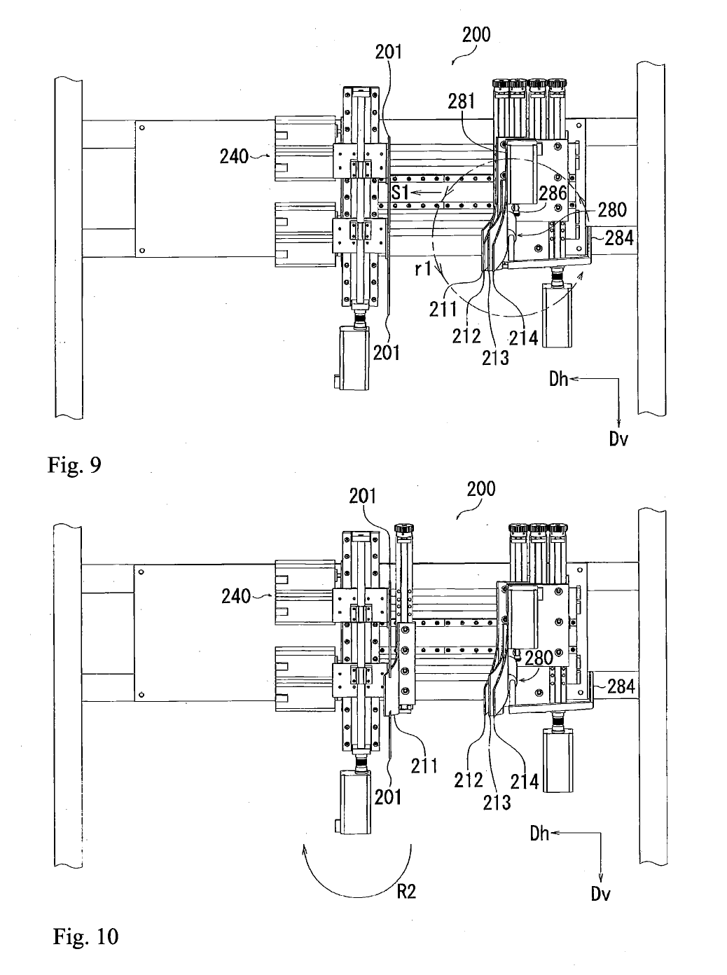

As illustrated in FIG. 9, the 41^{st} gear 286 is a bevel gear and is attached to the tip of the shaft of the bar rotary motor 281 while the axis thereof is matched with the rotary axis of the shaft of the bar rotary motor 281.

Similarly to the 41^{st} gear 286, the 42^{nd} gear is a bevel gear. The 42^{nd} gear is meshed with the 41^{st} gear 286 and is attached to the rear end of a shaft portion 282 (to be described) of the rotary bar 285 while the axis thereof is matched with the rotary axis of the shaft portion 282.

As illustrated in FIGS. 4 to 6, the rotary bar 285 mainly includes the shaft portion 282, a crank portion 283 and a contact bar portion 284. The shaft portion 282 is extended along the axis of the bar rotary motor 281. The crank portion 283 is extended from the tip of the shaft portion 282 along a direction roughly perpendicular to the axis of the shaft portion 282. The contact bar portion 284 is extended from the tip of the crank portion 283 towards the bar rotary motor along a direction parallel to the axial direction of the shaft portion 282.

In conjunction with driving of the bar rotary motor 281, the contact bar portion 284 is configured to pass through a space between the platen plates 201 and the folding plates 211 to 214 15, from above to below

(3) Transporting Mechanism

As illustrated in FIGS. 1 to 3, the transporting mechanism 300 mainly includes a pull-out plate 301, a pull-out plate up-and-down transporting mechanism 310, a pull-out plate rotary mechanism 320 and a pull-out plate back-and-forth transporting mechanism 330.

Elements of the transporting mechanism 300 will be hereinafter respectively explained in detail.

(3-1) Pull-Out Plate

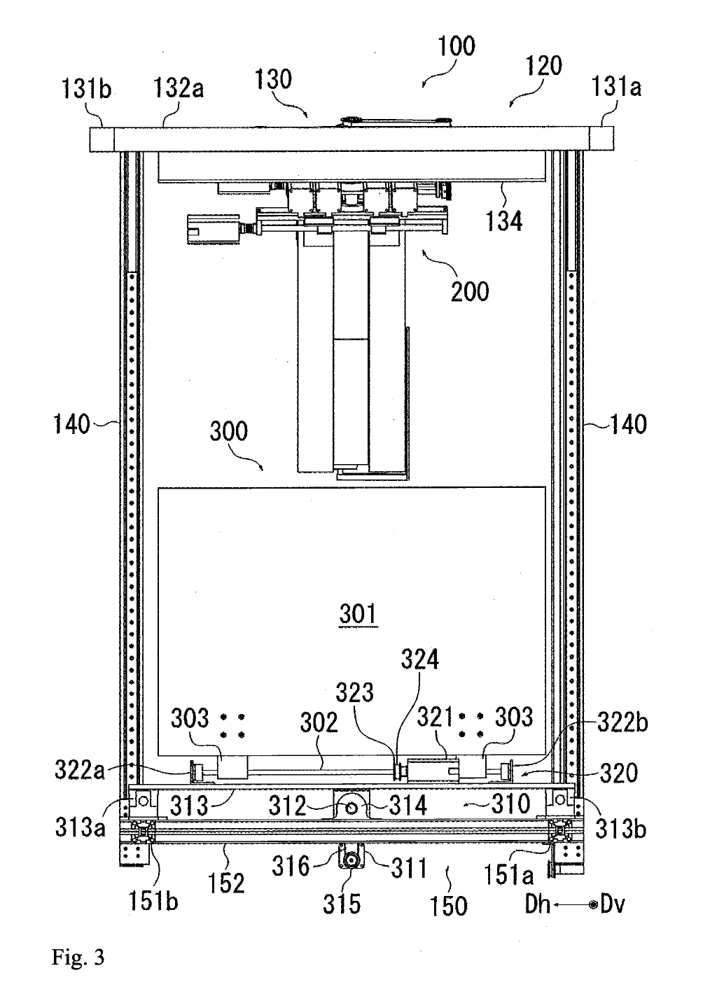

The pull-out plate 301 is a roughly rectangular plate member. It should be noted that the pull-out plate 301 includes two protrusions 303 and a rotary bar 302 as illustrated in FIG. 3. The protrusions 303 are backwardly extended, while the rotary bar 302 is fixed to the protrusions 303. Further, a 21^{st} pulley (not illustrated in the figures) is attached to the rotary bar 302.

(3-2) Pull-Out Plate Up-and-Down Transporting Mechanism

As illustrated in FIGS. 1 to 3, the pull-out plate up-and-down transporting mechanism 310 mainly includes a fourth ball screw 312, a fourth ball screw driving motor 311, a fourth nut 314, an attachment plate 313, a 11^{th} pulley 315, a 12^{th} pulley belt 316 and a 12^{th} pulley 317.

As illustrated in FIGS. 1 to 3, the fourth ball screw 312 is disposed while the axis thereof is arranged along the vertical direction Dv.

The fourth nut 314 is screwed onto the fourth ball screw 312. The fourth nut 314 is configured to be moved along the axial direction of the fourth ball screw 312 in conjunction with driving of the fourth ball screw driving motor 311.

The fourth nut 314 is fixed to the attachment plate 313. Further, the attachment plate 313 includes rail portions 313a and 313b on the both ends thereof. The rail portions 313a and 313b are fitted into the second pillar members 151a and 151b of the rear frame 150, respectively. Therefore, the attachment plate 313 is configured to be moved up and down along the second pillar members 151a and 151b when the fourth nut 314 is moved up and down along the fourth ball screw 312. Further, the pull-out plate 301 is attached to the front face of the attachment plate 313 through the pull-out plate rotary mechanism 320.

As illustrated in FIGS. 1 to 3, the 11^{th} pulley 315 is attached to the shaft of the fourth ball screw driving motor 311.

As illustrated in FIG. 3, the 12^{th} pulley 317 is attached to the bottom end of the fourth ball screw 312.

The 12^{th} pulley belt 316 is stretched over the 11^{th} pulley 315 and the 12^{th} pulley 317.

In other words, in conjunction with driving of the fourth ball screw driving motor 311, rotational power of the fourth ball screw driving motor 311 is transferred to the fourth ball screw 312 through the 11^{th} pulley 315, the 12^{th} pulley belt 316 and the 12^{th} pulley 317. As a result, the fourth ball screw 312 is rotated about the axis thereof. The attachment plate 313 is consequently moved up and down along the second pillar members 151a and 151b.

(3-3) Pull-Out Plate Rotary Mechanism

As illustrated in FIG. 3, the pull-out plate rotary mechanism 320 mainly includes rotary bar support bodies 322a and 322b, a 22^{nd} pulley 323, a 22^{nd} pulley belt 324 and a rotary bar driving motor 321.

The rotary bar support bodies 322a and 322b support the rotary bar 302 disposed rearwards of the pull-out plate 301 for allowing it to rotate.

The 22^{nd} pulley 323 is attached to the shaft of the rotary bar driving motor 321.

The 22^{nd} pulley belt 324 is stretched over the 22^{nd} pulley 323 and the 21^{st} pulley attached to the rotary bar 302.

In short, in conjunction with driving of the rotary bar driving motor 321, rotational power of the rotary bar driving motor 321 is transferred to the rotary bar 302 through the 22^{nd} pulley 323, the 22^{nd} pulley belt 324 and the 21^{st} pulley. As a result, the pull-out plate 301 is upwardly pivoted and lifted up.

(3-4) Pull-Out Plate Back-and-Forth Transporting Mechanism

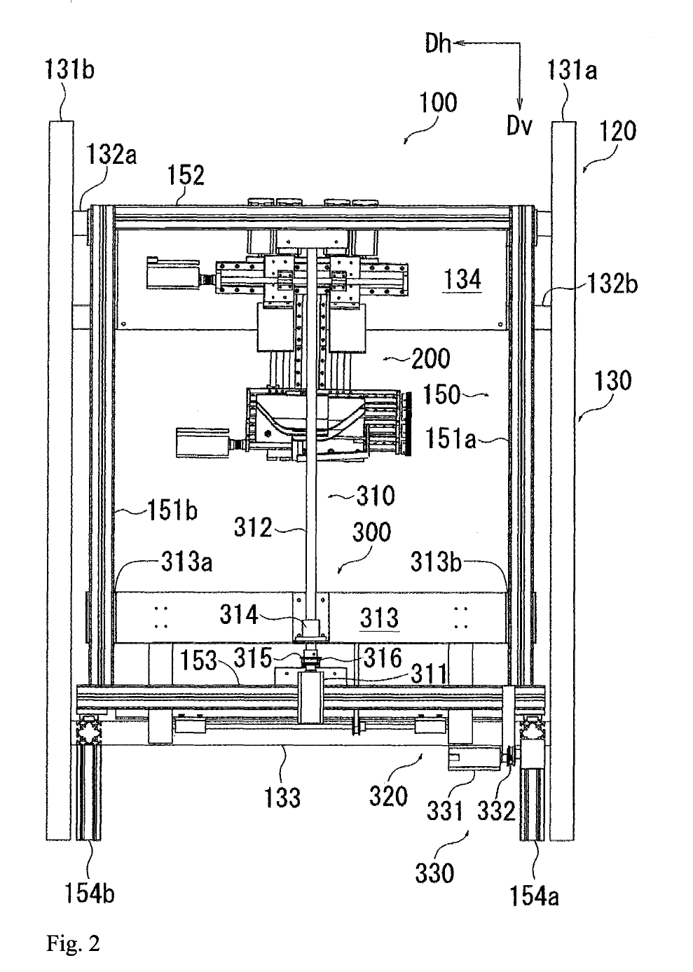

The pull-out plate back-and-forth transporting mechanism 330 is disposed for implementing back-and-forth movement of the transporting mechanism 300. As illustrated in FIG. 2, the pull-out plate back-and-forth transporting mechanism 330 mainly includes a back-and-forth driving motor 331, a wire (not illustrated in the figure) and a wire support portion 332.

In conjunction with driving of the back-and-forth driving motor 331, the wire is configured to be moved along the wire support portion 332. In conjunction with the wire movement, the transporting mechanism 300 is configured to be moved back and forth.

<Actions of Folding Device>

Actions of the folding device 100 according to the first exemplary embodiment of the present invention will be hereinafter explained with reference to the drawings.

In the folding device 100 according to the first exemplary embodiment of the present invention, the folding mechanism 200 is firstly set to be in a state illustrated in FIG. 8. In other words, the folding mechanism 200 is set to be in a state (initial state) that the folding plates 211 to 214 are disposed below the platen plates 201 while the opposed direction of the platen plates 201 and the folding plates 211 to 214 are matched with the vertical direction in a front view. In the state, a folding object (e.g., fabric) is put on the platen plates 201. It should be noted that the width between the platen plates 201 is adjusted by the inter-platen-plate distance adjusting mechanism 230 as described above.

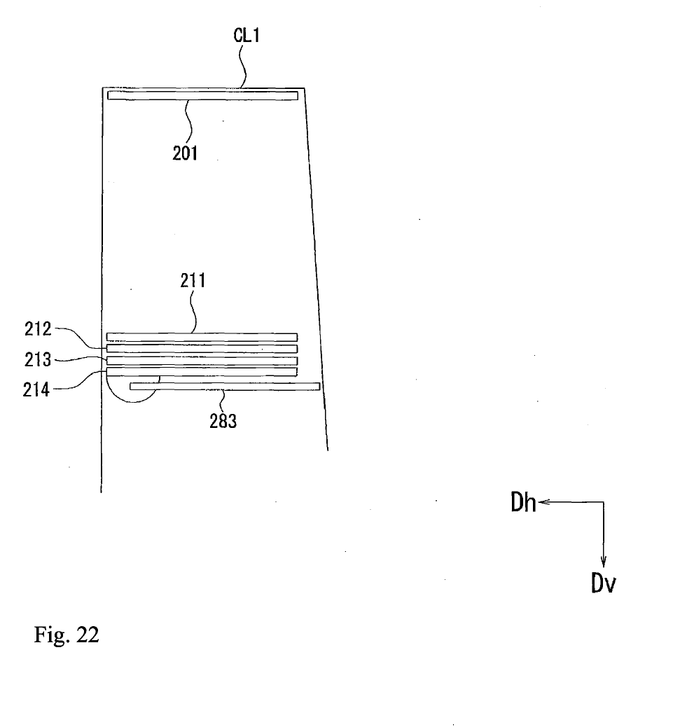

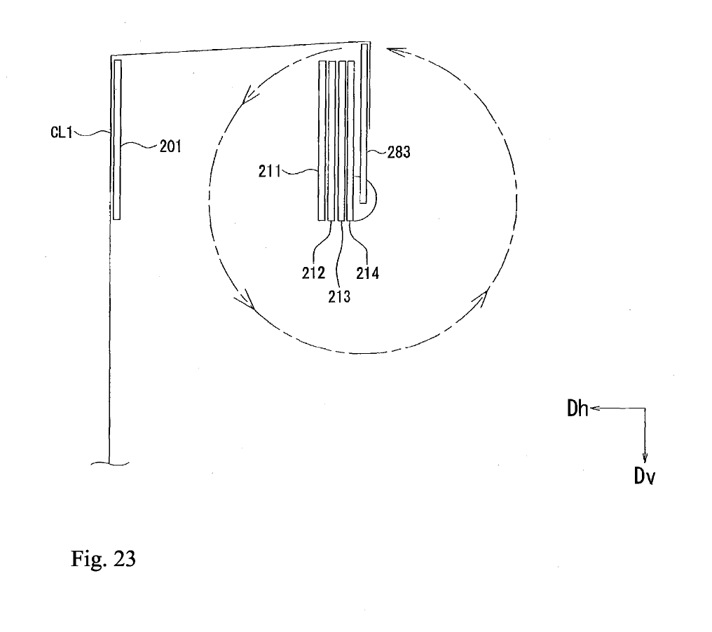

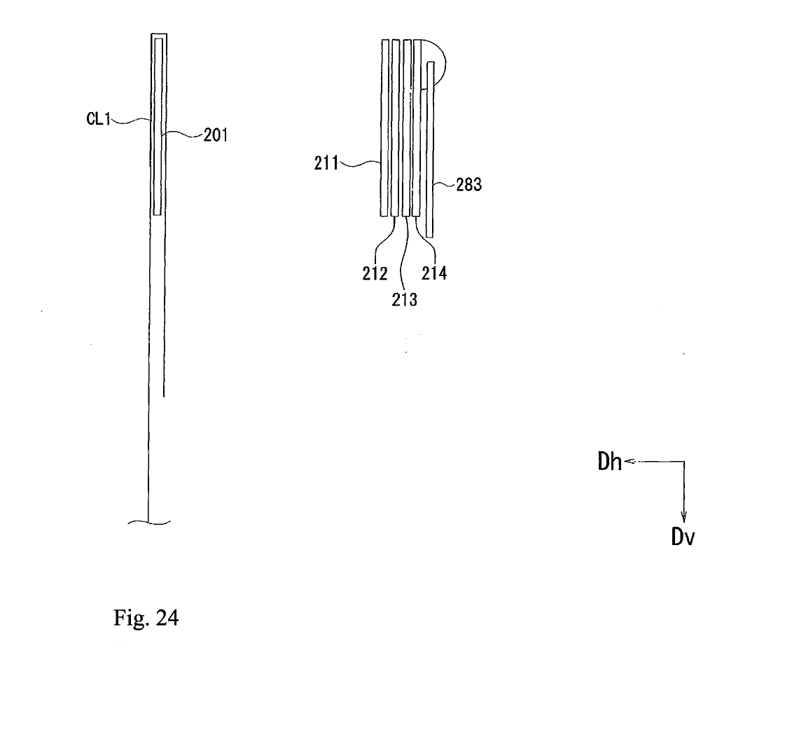

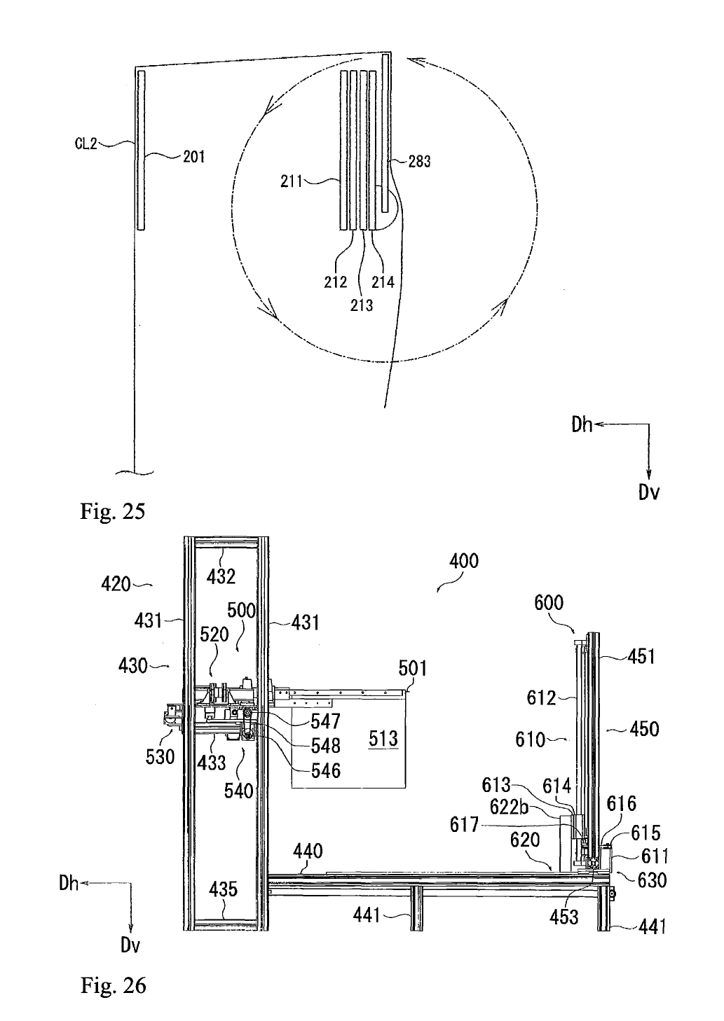

Next, the dual nested shaft rotary mechanism 220 rotates the folding mechanism 200 rightward (counterclockwisedly) at an angle of roughly 90 degrees in FIG. 8 (see an arrow R1 in FIG. 8). The folding mechanism 200 is thereby set to be in a state illustrated in FIG. 9 (a second state). In other words, the folding mechanism 200 is set to be in a state that the top faces of the platen plates 201 and those of the folding plates 211 to 214 are oriented leftward (i.e., a state that the slide moving direction of the folding plates 211 to 214 is directed from right to left and is roughly perpendicular to the vertical direction Dv in a front view). When the folding mechanism 200 is thus set to be in the state, the bar rotary motor 281 swivels the contact bar portion 284 at a predetermined number of times in an arrowed direction r1 in FIG. 9, i.e., from top to bottom within a space between the platen plates 201 and the first folding plate 211. When a part of the folding object herein gets stuck with the folding plates 211 to 214, the stuck portion of the folding object is dropped into the space between the platen plates 201 and the first folding plate 211 by the swivel action of the contact bar portion 284 (see simplified front views of FIGS. 22 to 25). When a folding object CL1 is put on the platen plates 201 while the hung down portion thereof does not reach the tip of the crank portion 283 (i.e., the lowest position of the contact bar portion 284) as illustrated in FIG. 23, the contact bar portion 284 is supposed to downwardly press the folding object CL1. Therefore, the hung down portion is dropped into the space between the platen plates 201 and the first folding plate 211 as illustrated in FIG. 24 when the contact bar portion 284 swivels only once or twice. On the other hand, when a folding object CL2 is put on the platen plates 201 while a hung down portion thereof reaches the tip of the crank portion 283 (i.e., the lowest position of the contact bar portion 284) as illustrated in FIG. 25, the contact bar portion 284 is supposed to upwardly lift the folding object CL2 in a space outward of the fourth folding plate 214 and drop the lifted up portion of the folding object CL2 into the space between the platen plates 201 and the first folding plate 211. Due to the configuration, the hung down portion of the folding object CL2 may not be dropped into the space between the platen plates 201 and the first folding plate 211 when the contact bar portion 284 is swiveled only once or twice. Therefore, the contact bar portion 284 is herein configured to be swiveled at a predetermined number of times greater than or equal to three times.

When swivel of the contact bar portion 284 is completed, the first folding plate sliding mechanism 240 slides and moves the first folding plate 211 towards the platen plates (see an arrow S1 in FIG. 9) as illustrated in FIG. 10, and the folding object is partially interposed and held between the platen plates 201 and the first folding plate 211 (a third state).

Next, the dual nested shaft rotary mechanism 220 rotates the folding mechanism 200 leftward (clockwisedly) at an angle of roughly 180 degrees in FIG. 10 (see an arrow R2 in FIG. 10).

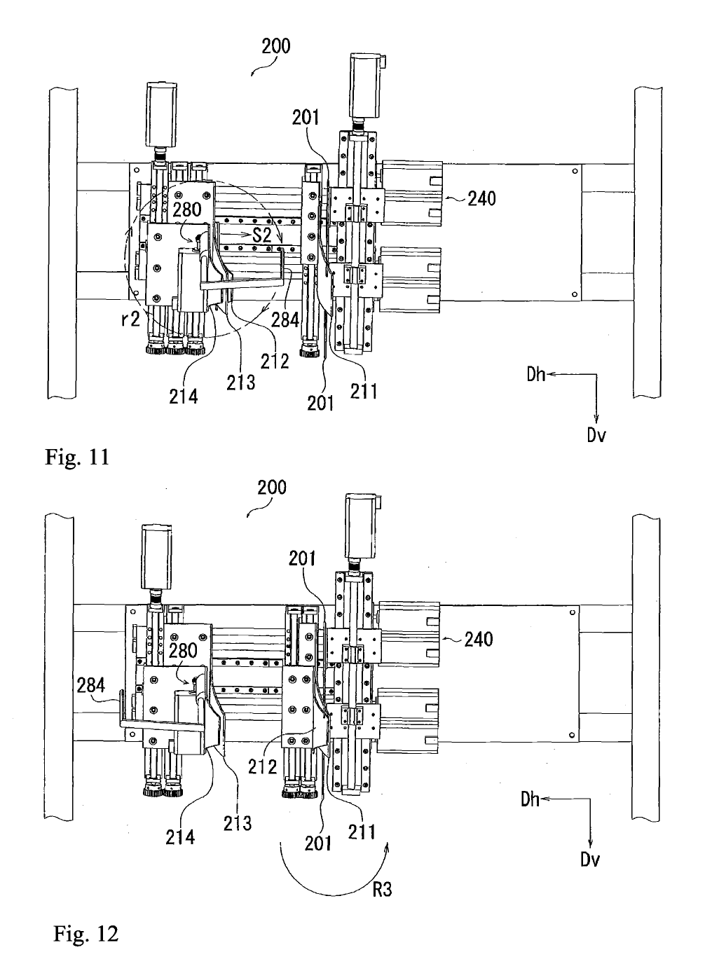

The folding mechanism 200 is thereby set to be in a state illustrated in FIG. 11 (a fourth state). In other words, the folding mechanism 200 is set to be in a state that the top faces of the platen plates 201 and those of the folding plates 211 to 214 are oriented rightward (i.e., a state that the slide moving direction of the folding plates 211 to 214 is directed from left to right and is roughly perpendicular to the vertical direction Dv in a front view). When the folding mechanism 200 is thus set to be in the state, the bar rotary motor 281 swivels the contact bar portion 284 at a predetermined number of times in an arrowed direction r2 in FIG. 11, i.e., from top to bottom within a space between the first folding plate 211 and the second folding plate 212.

When swivel of the contact bar portion 284 is completed, the first folding plate sliding mechanism 240 slides and moves the second folding plate 212 towards the platen plates (see an arrow S2 in FIG. 11) as illustrated in FIG. 12, and the folding object is partially interposed and held between the first folding plate 211 and the second folding plate 212 (a fifth state). It should be noted that the 32^{nd} gear 264b is herein meshed with the 31^{st} gear 264a.

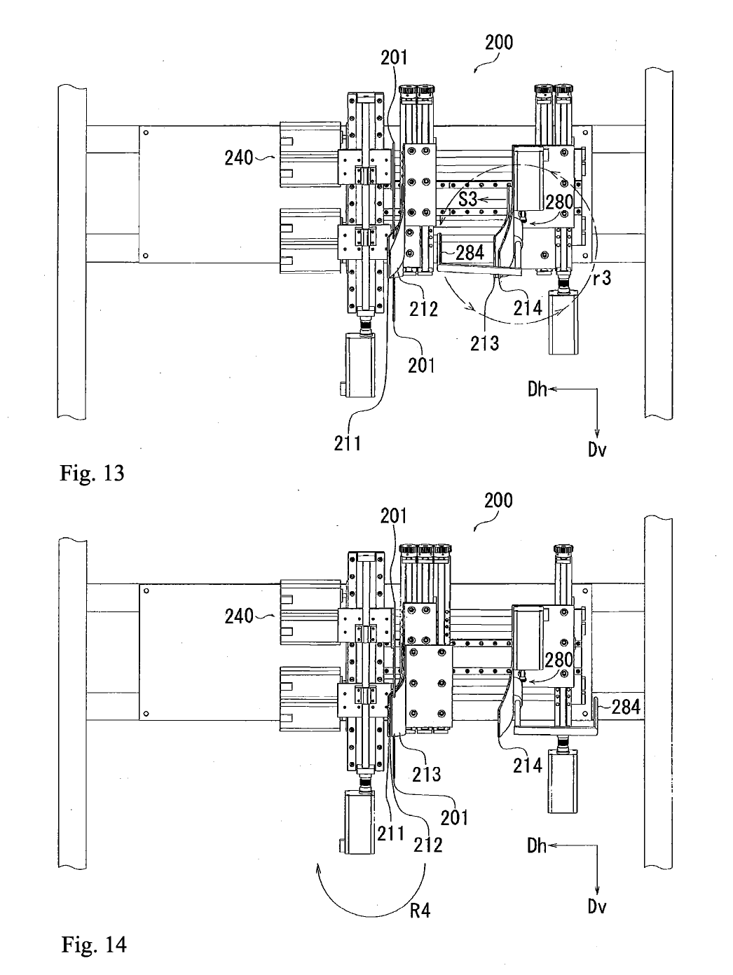

Next, the dual nested shaft rotary mechanism 220 rotates the folding mechanism 200 rightward (counterclockwisedly) at an angle of roughly 180 degrees in FIG. 12 (see an arrow R3 in FIG. 12). The folding mechanism 200 is thereby set to be in a state illustrated in FIG. 13 (a sixth state). In other words, the folding mechanism 200 is set to be in a state that the top faces of the platen plates 201 and those of the folding plates 211 to 214 are oriented leftward (i.e., a state that the slide moving direction of the folding plates 211 to 214 is directed from right to left and is roughly perpendicular to the vertical direction Dv in a front view). When the folding mechanism 200 is thus set to be in the state, the bar rotary motor 281 swivels the contact bar portion 284 at a predetermined number of times in an arrowed direction r3 in FIG. 13, i.e., from top to bottom within a space between the second folding plate 212 and the third folding plate 213.

When swivel of the contact bar portion 284 is completed, the first folding plate sliding mechanism 240 slides and moves the third folding plate 213 towards the platen plates (see an arrow S3 in FIG. 13) as illustrated in FIG. 14, and the folding object is partially interposed and held between the second folding plate 212 and the third folding plate 213 (a seventh state). It should be noted that the 33^{rd} gear 264c is herein meshed with the 32^{nd} gear 264b.

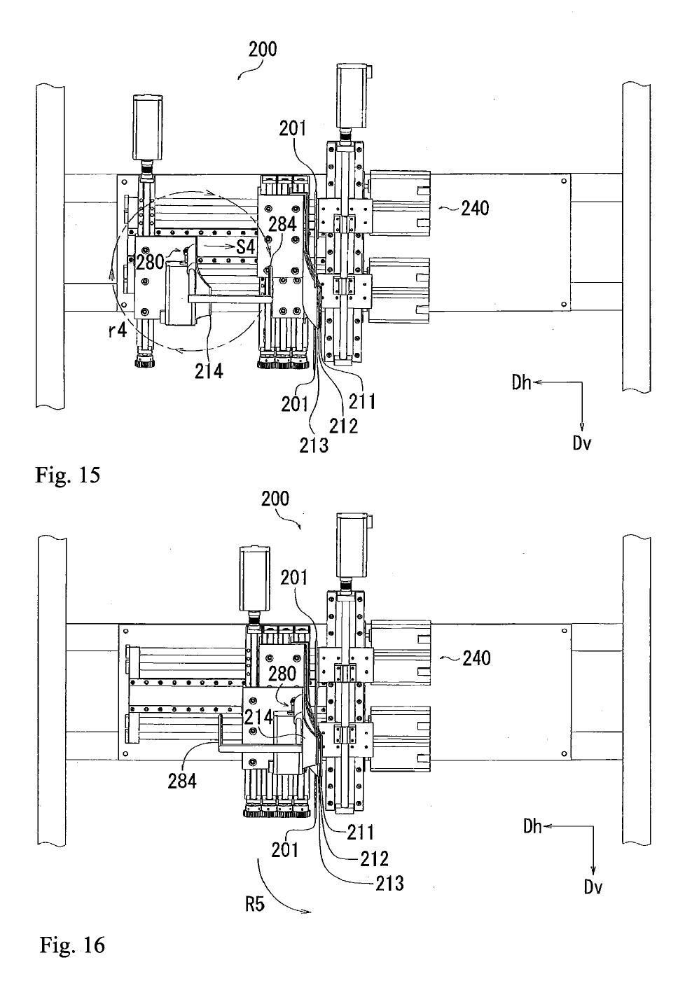

Next, the dual nested shaft rotary mechanism 220 rotates the folding mechanism 200 leftward (clockwisedly) at an angle of roughly 180 degrees in FIG. 14 (see an arrow R4 in FIG. 14). The folding mechanism 200 is thereby set to be in a state illustrated in FIG. 15 (an eighth state). In other words, the folding mechanism 200 is set to be in a state that the top faces of the platen plates 201 and those of the folding plates 211 to 214 are oriented rightward (i.e., a state that the slide moving direction of the folding plates 211 to 214 is directed from left to right and is roughly perpendicular to the vertical direction Dv in a front view). When the folding mechanism 200 is thus set to be in the state, the bar rotary motor 281 swivels the contact bar portion 284 at a predetermined number of times in an arrowed direction r4 in FIG. 15, i.e., from top to bottom within a space between the third folding plate 213 and the fourth folding plate 214.

When swivel of the contact bar portion 284 is completed, the first folding plate sliding mechanism 240 slides and moves the fourth folding plate 214 towards the platen plates (see an arrow S4 in FIG. 15) as illustrated in FIG. 16, and the folding object is partially interposed and held between the third folding plate 213 and the fourth folding plate 214 (a ninth state). It should be noted that the 34^{th} gear 264d is herein meshed with the 33^{rd} gear 264c.

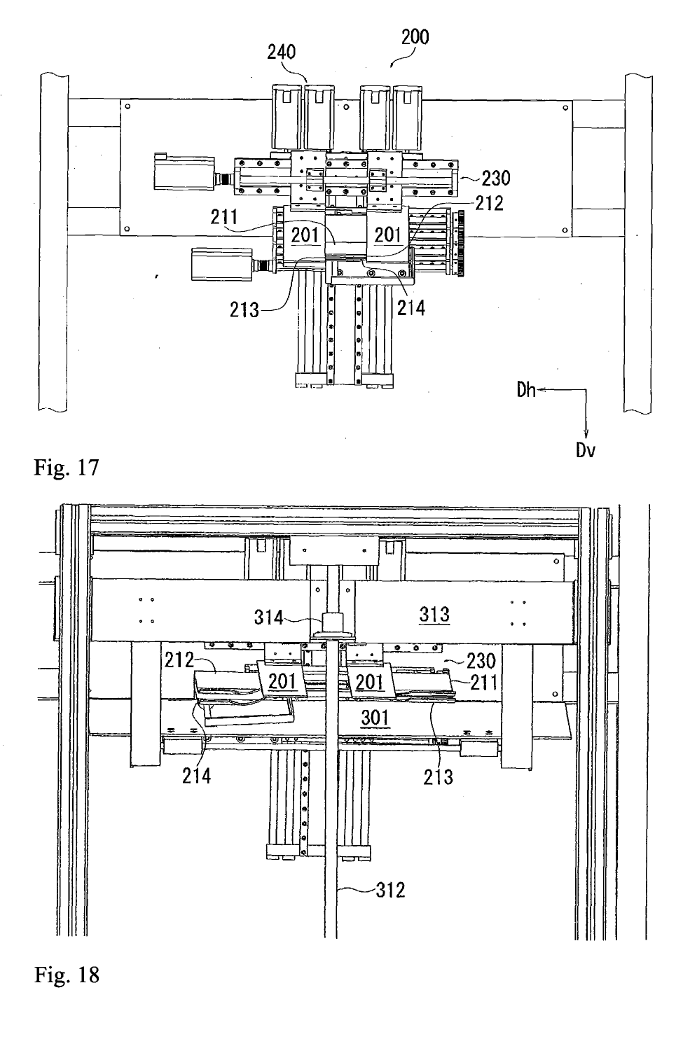

Next, the dual nested shaft rotary mechanism 220 rotates the folding mechanism 200 rightward (counterclockwisedly) at an angle of roughly 90 degrees in FIG. 16 (see an arrow R5 in FIG. 16). The folding mechanism 200 is thereby set to be in a state illustrated in FIG. 17 (a tenth state). In other words, the folding mechanism 200 is set to be in a state that the top faces of the platen plates 201 and those of the folding plates 211 to 214 are oriented obliquely upward.

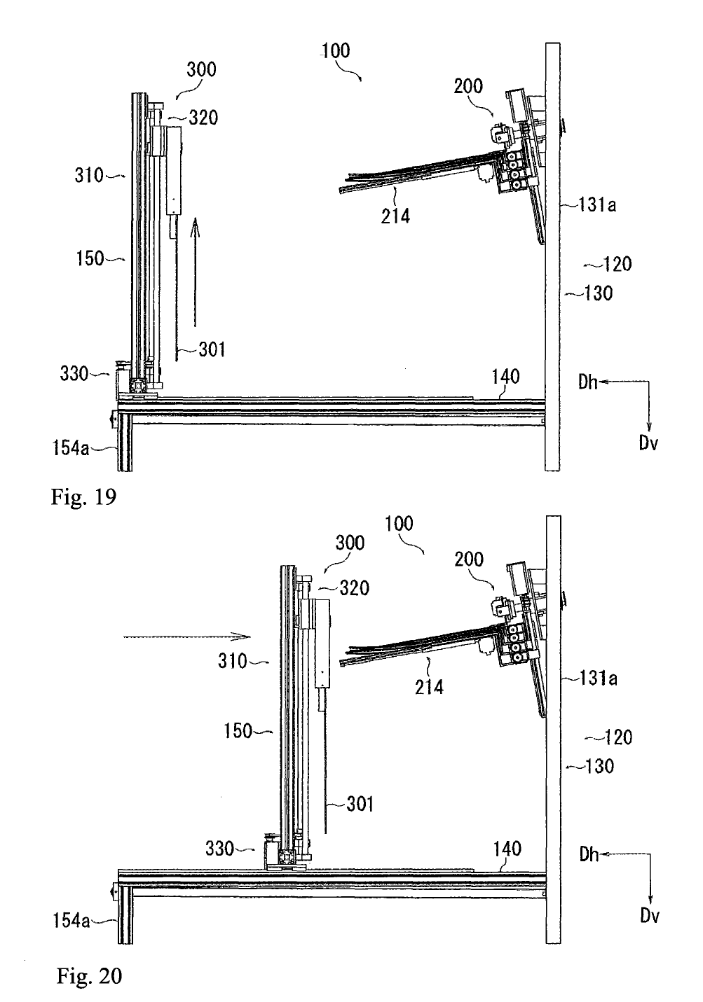

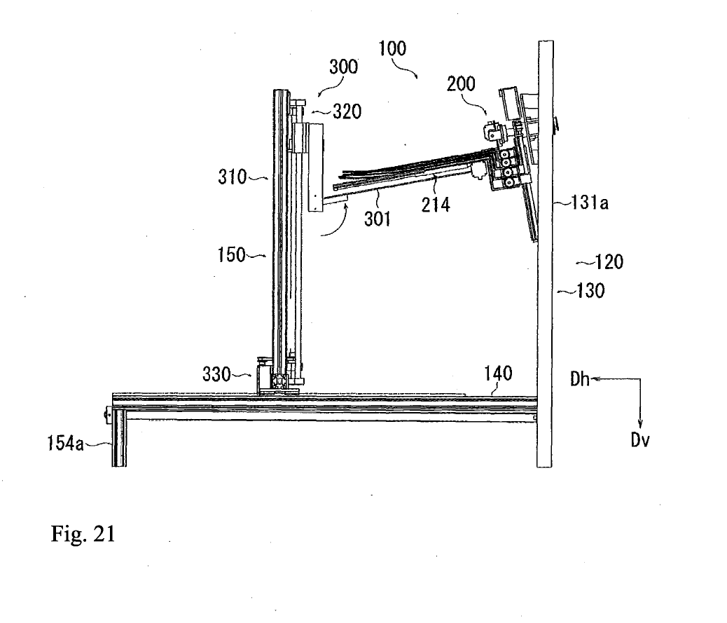

Next, the pull-out plate up-and-down transporting mechanism 310 lifts up the pull-out plate 301 to a predetermined height as illustrated in FIG. 19 (a second state). The pull-out plate back-and-forth transporting mechanism 330 then forwardly moves the pull-out plate 301 to a predetermined position as illustrated in FIG. 20 (a third state). It should be noted that the pull-out plate 301 is herein positioned while the plate face thereof is arranged along the vertical direction Dv. The pull-out plate rotary mechanism 320 then pivots the pull-out plate 301 to a position where the pull-out plate 301 is disposed roughly in parallel to the fourth folding plate 214 as illustrated in FIG. 21 (a fourth state).

As illustrated in FIG. 18, the second folding plate sliding mechanism 260 subsequently slides and moves the first folding plate 211 rightward in FIG. 18, slides and moves the second folding plate 212 leftward in FIG. 18, slides and moves the third folding plate 213 rightward in FIG. 18, and slides and moves the fourth folding plate 214 leftward in FIG. 18 (an eleventh state). In other words, the folding plates 211 to 214 are removed from the folding object, and the folding object can be easily pulled out by means of the pull-out plate 301.

Finally, the pull-out plate 301 is lifted down by the pull-out plate up-and-down transporting mechanism 310, while being backwardly moved by the pull-out plate back-and-forth transporting mechanism 330. The pull-out plate 301 is thereby set to be in a state illustrated in FIG. 1.

It should be noted that the aforementioned actions of the folding device 100 are configured to be executed by a control device (not illustrated in the figures).

<Features of Folding Device>

(1)

In the folding device 100 according to the present exemplary embodiment, the folding plates 211 to 214 are disposed for opposing to the platen plates 201 and are configured to be slid and moved with respect to the platen plates 201. With the structure, the swivel radius of the folding plates 211 to 214 can be reduced in the folding device 100. Therefore, the folding device 100 can be compactly formed.

(2)

The folding device 100 according to the present exemplary embodiment is provided with the rotary bar mechanism 280. Even when a folding object gets stuck with the folding plates 211 to 214 during the swivel movement of the folding plates 211 to 214, the rotary bar mechanism 280 drops the stuck portion of the folding object into either the space between the platen plates 201 and the folding plates 211 to 214 or the space between any two of the folding plates 211 to 214. Therefore, the folding device 100 can fold a folding object of any size using the platen plates 201 and the folding plates 211 to 214.

(3)

In the folding device 100 according to the present exemplary embodiment, each of the folding plates 211 to 214 has a roughly right-angled trapezoid shape in a plan view. Each of the first and third folding plates 211 and 213 is aligned to the left in FIG. 5 while the hypotenuse thereof is positioned on the left side in FIG. 5. On the other hand, each of the second and fourth folding plates 212 and 214 is aligned to the right in FIG. 5 while the hypotenuse thereof is positioned on the right side in FIG. 5. Therefore, when a folding object is a long sleeve shirt or the like, the folding device 100 can set the sleeve parts of the folding object to be hung down to the straight downward. Further, the folding device 100 can tidily fold the folding object without producing wrinkles in the sleeve parts of the folding object.

<Modifications>

(A)

In the folding device 100 according to the aforementioned exemplary embodiment, the inter-platen-plate distance adjusting mechanism 230 can adjust the width between the platen plates 201. In such a case that folding objects with the same size are prepared, the inter-platen-plate distance adjusting mechanism 230 may be removed and only a single platen plate may be used.

(B)

In the folding device 100 according to the aforementioned exemplary embodiment, four folding plates 211 to 214 are provided. However the number of the folding plates 211 to 214 is not particularly limited, and may be increased or decreased in accordance with the shape or size of a folding object.

(C)

In the folding device 100 according to the aforementioned exemplary embodiment, the folding mechanism 200 is rotated right and left from the position of the initial state at an angle of roughly 90 degrees with respect to the vertical direction in a front view. However, the folding mechanism 200 may be rotated right and left at an angle of greater than 90 degrees.

(D)

The folding plates 211 to 214 may be frame-shaped members or stick-shaped members, although not particularly described in the aforementioned exemplary embodiment. When the folding plates 211 to 214 are herein the stick-shaped members, it is required to respectively dispose the stick-shaped members in positions corresponding to those of the left-side hypotenuse of the first folding plate 211, the right-side hypotenuse of the second folding plate 212, the left-side hypotenuse of the third folding plate 213 and the right-side hypotenuse of the fourth folding plate 214. It should be noted that the present technical idea becomes opposite when being applied to the following exemplary modification (F). Specifically, it is herein required to respectively dispose the stick-shaped members in positions corresponding to those of the right-side hypotenuse of the first folding plate 211, the left-side hypotenuse of the second folding plate 212, the right-side hypotenuse of the third folding plate 213 and the left-side hypotenuse of the fourth folding plate 214.

(E)

In the folding device 100 according to the aforementioned exemplary embodiment, the contact bar portion 284 is configured to be swiveled at a predetermined number of times. Alternatively, a detector unit (e.g., a photoelectric sensor or an infrared sensor) may be disposed on the back face of the fourth folding plate 214, i.e., on the side where the rotary bar mechanism 280 is disposed in order to detect whether or not a folding object exists. Further, the contact bar portion 284 may be configured to be swiveled until the detector unit no longer detects existence of the folding object. In this case, a sensor light receiver may be preliminarily disposed on the back face of the fourth folding plate 214 while sensor light emitters may be disposed on the both sides of the platen plates 201. Alternatively, a sensor light emitter may be preliminarily disposed on the back face of the fourth folding plate 214 while sensor light receivers may be disposed on the both sides of the platen plates 201. With the structure, the stuck portion of a folding object can be reliably dropped into either the space between the platen plates 201 and the first folding plate 211 or the space between any two of the folding plates 211 to 214. Further, it is possible to minimize a period of time required for executing the dropping processing.

(F)

In the folding device 100 according to the aforementioned exemplary embodiment, the folding mechanism 200 is configured to be rotated rightward in FIG. 8 at an angle of roughly 90 degrees, then rotated leftward in FIG. 10 at an angle of roughly 180 degrees, further rotated rightward in FIG. 12 at an angle of roughly 180 degrees, yet further rotated leftward in FIG. 14 at an angle of roughly 180 degrees, and finally rotated rightward in FIG. 16 at an angle of roughly 90 degrees. However, the folding mechanism 200 may be configured to be rotated leftward in FIG. 8 at an angle of roughly 90 degrees, then rotated rightward. therefrom at an angle of roughly 180 degrees, further rotated leftward therefrom at an angle of roughly 180 degrees, yet further rotated rightward therefrom at an angle of roughly 180 degrees, and finally rotated leftward therefrom at an angle of roughly 90 degrees. It should be herein noted that all the rotational directions of the third gears 264a to 264d are required to be reversed in the second folding plate sliding mechanism 260.

(G)

In the folding device 100 according to the aforementioned exemplary embodiment, driving of pulleys, pulley belts, gears, a motor direct connection structure and etc. are utilized in the folding mechanism 200 and the transporting mechanism 300. However, utilization of driving of the elements can be arbitrarily selected without departing from the scope of the present invention.

(H)

In the folding device 100 according to the aforementioned exemplary embodiment, the platen plates 201 and the folding plates 211 to 214 are designed to be rotated without changing the opposed relation thereof. However, the platen plates 201 and the folding plates 211 to 214 may be rotated in different timings as long as the opposed relation thereof can be maintained when the rotational action of the folding mechanism 200 is stopped (i.e., the second, fourth, sixth and eighth states).

(I)

In the folding device 100 according to the aforementioned exemplary embodiment, the folding plates 211 to 214 are disposed below and in parallel to the platen plates 201, and are configured to be slid and moved towards the platen plates 201. However, the folding plates may be disposed below the platen plates while being opened at an angle of roughly 90 degrees with respect to the platen plates, and may be configured to be rotated towards the platen plate as described in the brochure of International Patent Application Publication No. WO2008/032826.

(J)

In the folding device 100 according to the aforementioned exemplary embodiment, four third gears 264a to 264d are configured to be completely meshed with each other during execution of the folding action of the folding mechanism 200. Alternatively, the first folding plate sliding mechanism 240 may be configured to extend the intervals among the folding plates 211 to 214 (i.e., the folding plates 211 to 214 may be slightly slid and moved in a direction opposite to the slide moving direction during execution of the folding action) after the folding mechanism 200 is set to be in the tenth state so that four third gears 264a to 264d are meshed with each other, for instance, at roughly only one-fourth to half the working depth of the completely meshed state. With the structure, it is possible to easily pull out the folding plates 211 to 214 from a folding object, and simultaneously, avoid applying excessive friction to the folding object when the second folding plate sliding mechanism 260 removes the folding plates 211 to 214 from the folding object.

(K)

The inter-platen-plate distance adjusting mechanism 230 may be configured to reduce the distance between the platen plates 201 before the folding object is pulled out by the pull-out plate 301 after the folding mechanism 200 is set to be in the tenth state, although not particularly described for the folding device 100 according to the aforementioned exemplary embodiment. With the configuration, tension applied to a folding object by the platen plates 201 is relieved and the folding object can be easily pulled out. Further, it is possible to prevent the folding object from getting stuck with the platen plates 201 and being thereby damaged.

(L)

When the folding mechanism 200 folds a folding object in the folding device 100 according to the aforementioned exemplary embodiment, the pull-out plate up-and-down transporting mechanism 310 is configured to lift up the pull-out plate 301 to a predetermined height (the second state) as illustrated in FIG. 19, and the pull-out plate back-and-forth transporting mechanism 330 is then configured to forwardly move the pull-out plate 301 to a predetermined position (the third state) as illustrated in FIG. 20. Further, the pull-out plate rotary mechanism 320 is configured to rotate the pull-out plate 301 to a position where the pull-out plate 301 is arranged roughly in parallel to the fourth folding plate 214 (the fourth state) as illustrated in FIG. 21. However, after the folding mechanism 200 folds the folding object, the pull-out plate up-and-down transporting mechanism 310 may be configured to lift up the pull-out plate 301 to a predetermined height, and then, the pull-out plate rotary mechanism 320 may be configured to rotate the pull-out plate 301 to a roughly horizontal position. Thereafter, the pull-out plate back-and-forth transporting mechanism 330 may be configured to forwardly move the pull-out plate 301 to a predetermined position.

(M)

In the folding device 100 according to the aforementioned exemplary embodiment, the action of the pull-out plate 301 is controlled by the transporting mechanism 300. However, the action of the pull-out plate 301 may be controlled by either a robot-hand attached multi-axis robot arm or a robot-hand attached Cartesian coordinate robot. It should be noted that the number of the robot-hand attached multi-axis robot arms herein provided may be one, or alternatively, two or more. When the robot-hand attached Cartesian coordinate robot is herein used, the number of robot hands attached thereto may be one, or alternatively, two or more. In this case, the pull-out plate is preferably provided with a portion (or portions) (hereinafter referred to as “a clamped portion (or clamped portions)”) to be clamped by the robot hand (or robot hands). For example, the clamped portion may be either a sidewall upwardly extended from the rear end (or the vicinity of the rear end) of the pull-out plate or a sidewall upwardly extended from the lateral end (or the vicinity of the lateral end) of the pull-out plate. In the latter case, the pull-out plate may include either the sidewall on either of the lateral ends thereof (or the vicinity of either of the lateral ends thereof) or the sidewalls on the both lateral ends thereof (or the vicinity of the both lateral ends thereof). Further, the action of the pull-out plate may be configured to be identical to that of the pull-out plate 301 in the folding device 100 according to the aforementioned exemplary embodiment, or alternatively, identical to that of the pull-out plate 301 described in the aforementioned exemplary modification (L).

(N)

A folding object storage box is preferably disposed beside the folding mechanism 200, although not particularly described in the aforementioned exemplary embodiment. It should be noted that the folding object storage box is preferably at least opened towards the rear frame of the folding device 100 in the back-and-forth direction and is further preferably opened upwards. In this case, the folding object, folded by the folding device 100, is configured to be stored in the folding object storage box as follows.

First, the pull-out plate, putting a folding object thereon, is moved backwards so that the tip of the pull-out plate is positioned rearwards of the storage opening of the folding object storage box in a side view. Next, the pull-out plate is moved in both the up-and-down direction and the right-and-left direction so that the pull-out plate is opposed to the storage opening of the folding object storage box. Subsequently, the pull-out plate is forwardly moved towards the folding object storage box and is inserted into the storage space of the folding object storage box. To implement a series of these actions of the pull-out plate, it is required to preliminarily set a coordinate in an action program. Next, a folding objet stopper is lifted down towards either the folding object or the rear end (opposite to the tip) of the pull-out plate. It should be noted that the folding object stopper may be of a lever type, or alternatively, of a shutter type. A pull-out plate 601 is then moved backwards while the folding object stopper is completely lifted down. The folding object is accordingly stored in the storage space of the folding object storage box.

To implement the actions of the pull-out plate, the transporting mechanism 300 according to the aforementioned exemplary embodiment further requires a second pull-out plate back-and-forth transporting mechanism and a pull-out plate right-and-left transporting mechanism. The second pull-out plate back-and-forth transporting mechanism is disposed in parallel, to the pull-out plate back-and-forth transporting mechanism 330, whereas the pull-out plate right-and-left transporting mechanism implements movement of the pull-out plate 301 between the pull-out plate back-and-forth transporting mechanism 330 and the second pull-out plate back-and-forth transporting mechanism. When a pull-out plate rotary mechanism is herein further provided, the pull-out plate 301 can be more flexibly moved. In this case, a method of disposing the folding object storage box is not particularly limited as long as the folding object storage box is disposed within the operable range of the transporting mechanism. It should be noted that any person skilled in the art of the present invention can easily embody the structure and configuration. Therefore, detailed explanation thereof will be hereinafter omitted.

Further, the aforementioned actions of the pull-out plate can be implemented utilizing either the robot-hand attached multi-axis robot arm or the robot-hand attached Cartesian coordinate type robot according to the aforementioned exemplary modification (M) instead of the transporting mechanism 300 according to the aforementioned exemplary embodiment. In this case, a method of disposing the folding object storage box is not particularly limited as long as the folding object storage box is disposed within the operable range of either the robot-hand attached multi-axis robot arm or the robot-hand attached Cartesian coordinate type robot.

(O)

A platen plate tip position moving mechanism (not illustrated in the figures) may be further provided for moving back and forth the position of the longitudinally rear frame side tip of the platen plates 201 along the longitudinal direction of the platen plates 201, although not particularly described for the folding device 100 according to the aforementioned exemplary embodiment. The platen plate tip position moving mechanism is preferably configured to move the tips of the platen plates 201 at least from (i) the tip positions of the folding plates 211 to 214 to (ii) positions shifted from the tip positions of the folding plates 211 to 214 by a length of several centimeters or tens of centimeters. It should be noted that the platen plate tip position moving mechanism of this type can be structured using a boll screw mechanism. For example, the platen plates 201 may be configured to be extended and contracted by longitudinally splitting the plate plates 201 into two pieces and then coupling the split platen plate pieces by a ball screw mechanism disposed while the rotational axis thereof is arranged along the longitudinal direction of the split platen plate pieces. Further, the ball screw mechanism may be configured to move back and forth the inter-platen-plate distance adjusting mechanism 230 along the longitudinal direction of the platen plates 201 (this can be also implemented by moving back and forth the inner shaft 221a).

In the folding device thus including the platen plate tip position moving mechanism, a folding object is put on the platen plates 201 while the tips of the platen plates 201 are protruded from the tip positions of the folding plates 211 to 214. A part of the folding object is interposed and held between the platen plates 201 and the first folding plate 211, while another part of the folding object is interposed and held between the first folding plate 211 and the second folding plate 212. Subsequently, the platen plate tip position moving mechanism is configured to backwardly move the tips of the platen plates 201 to the tip positions of the folding plates 211 to 214. It should be noted that the backward movement may be executed at the timing when the above-mentioned another part of the folding object is interposed and held between the second folding plate 212 and the third folding plate 213, or alternatively, at the timing when the above-mentioned another part of the folding object is interposed and held between the third folding plate 213 and the fourth folding plate 214.

(P)

The aforementioned exemplary modifications (A) to (O) may be used in arbitrarily combinations.

For example, the actions of the pull-out plate may be configured as follows.

First, the clamped portion of the pull-out plate disposed below the folding mechanism 200 is clamped in two positions by means of either two robot-hand attached multi-axis robot arms or two robot hands of two robot-hand attached Cartesian coordinate type robots (hereinafter simply referred to as “robots”) (see the aforementioned exemplary modification (M)). Next, the robots move the pull-out plate to the rearward of the folding mechanism 200 (see the aforementioned exemplary modification (N)). Next, the first folding plate sliding mechanism 240 expands the intervals among the folding plates 211 to 214 while four third gears 264a to 264d are meshed with each other, for instance, at roughly only one-fourth to half the working depth of the completely meshed state (see the aforementioned exemplary modification (J)). Subsequently, the robots forwardly move the pull-out plate towards the folding object such as a shirt that the both sleeves thereof have been already folded and only the hems thereof are hung down (see the aforementioned exemplary modifications (L) and (M)). As a result, the hems are folded by the pull-out plate. Next, the second folding plate sliding mechanism 260 slides and moves the first folding plate 211 rightward in FIG. 18, slides and moves the second folding plate 212 leftward in FIG. 18, slides and moves the third folding plate 213 rightward in FIG. 18, and slides and moves the fourth folding plate 214 leftward in FIG. 18 (the eleventh state). Subsequently, the robots backwardly move the pull-out plate. As a result, the folded shirt or the like is removed from the platen plates 201 and put on the pull-out plate. Further, the shirt or the like is stored in the folding object storage box as described in the aforementioned exemplary modification (N).

### Second Exemplary Embodiment

As illustrated in FIGS. 26 to 28, a folding device 400 of a second exemplary embodiment of the present invention mainly includes a frame 420, a folding mechanism 500 and a transporting mechanism 600.

Elements of the folding device 400 will be hereinafter respectively described in detail.

<Structure of Folding Device>

(1) Frame

As illustrated in FIGS. 26 to 28, the frame 420 is mainly formed by a front frame 430, side frames 440 and a rear frame 450.

Elements of the frame 420 will be hereinafter respectively described in detail.

(1-1) Front Frame

As illustrated in FIGS. 26 to 28, the front frame 430 is mainly formed by four first pillar members 431, four first upper beam members 432, four first intermediate beam members 433, a second intermediate beam member 434 and four first lower beam members 435.

The first pillar members 431 are disposed while the axes thereof are arranged along the vertical direction Dv.

The first upper beam members 432 are extended among the first pillar members 131 in the horizontal direction Dh in order to connect the top ends of the first pillar members 131.

The first intermediate beam members 433 are extended among the first pillar members 431 in the horizontal direction Dh in order to connect the intermediate parts of the first pillar members 131 in the height direction. It should be noted that the folding mechanism 500 is fixed to the first intermediate beam members 433 as illustrated in FIGS. 26 to 28.

The second intermediate beam member 434 is extended between rear-frame side two of the first pillar members 431 in the horizontal direction Dh in order to connect parts, positioned slightly above the bottom ends, of the rear-frame side two first pillar members 431.

The first lower beam members 435 are extended among the first pillar members 131 in the horizontal direction Dh in order to connect the bottom ends of the first pillar members 131.

(1-2) Side Frames

As illustrated in FIGS. 26 to 28, the side frames 440 are two beam members, each of which connects a lower part of the front frame 430 and that of the rear frame 450. Further, four leg members 441 are attached to the side frames 440.

(1-3) Rear Frame

As illustrated in FIGS. 26 to 28, the rear frame 450 is mainly formed by two second pillar members 451, a second upper beam member 452 and a second lower beam member 453. It should be noted that the transporting mechanism 600 is attached to the rear frame 150.

The second pillar members 451 are disposed while the axes thereof are arranged along the vertical direction Dv.

The second upper beam member 452 is extended between the second pillar members 451 in the horizontal direction Dh in order to couple the top ends of the second pillar members 451.

The second lower beam member 453 is extended under the second pillar members 451 in the horizontal direction Dh in order to couple the bottom ends of the second pillar members 451.

(2) Folding Mechanism

As described above, the folding mechanism 500 is fixed to the first intermediate beam members 433. As illustrated in FIGS. 26 to 28, the folding mechanism 500 mainly includes a pair of platen plates 501, four folding plates 511 to 514, dual nested shaft rotary mechanisms 520, an inter-platen-plate distance adjusting mechanism 530 and folding plate sliding mechanisms 540. It should be noted that the folding plates with reference numerals of 511, 512, 513 and 514 may be hereinafter referred to as “a first folding plate”, “a second folding plate”, “a third folding plate” and “a fourth folding plate”.

Elements of the folding mechanism 500 will be hereinafter respectively explained in detail.

(2-1) Platen Plates

The platen plates 501 are a pair of roughly rectangular plate members. As illustrated in FIG. 26, each platen plate 501 is extended towards the rear frame in the horizontal direction. In an initial state, a folding object (e.g., clothing) is put on the platen plates 501.

Further, the distance (width) between the platen plates 501 is adjusted by the inter-platen-plate distance adjusting mechanism 530. It should be noted that the separated distance (width) between the platen plates 501 is adjusted in accordance with the clothing size and/or the like.

Yet further, the tips of the platen plates 501 are preferably further protruded towards the rear frame than those of the folding plates 511 to 514 in a plan view. It should be noted that the protruded length depends on the shape and/or the size of the folding object. When the folding object is a T-shirt, for instance, the protruded length is preferably set to be greater than or equal to 3 cm and is more preferably set to be greater than or equal to 5 cm. The reason of this configuration is as follows. When the folding object is a shirt or the like, the folding object can be tidily folded while the hems thereof are prevented from being rolled up the folding plates 511 to 514.

(2-2) Folding Plate

The folding plates 511 to 514 are members for serving to fold a folding object put on the platen plates 501. As illustrated in FIGS. 26 to 28, each of the folding plates 511 to 514 has a roughly rectangular shape. The folding plates 511 to 514 are disposed beside the platen plates 501 while being arranged perpendicularly thereto in an initial state.

(2-3) Dual Nested Shaft Rotary Mechanism

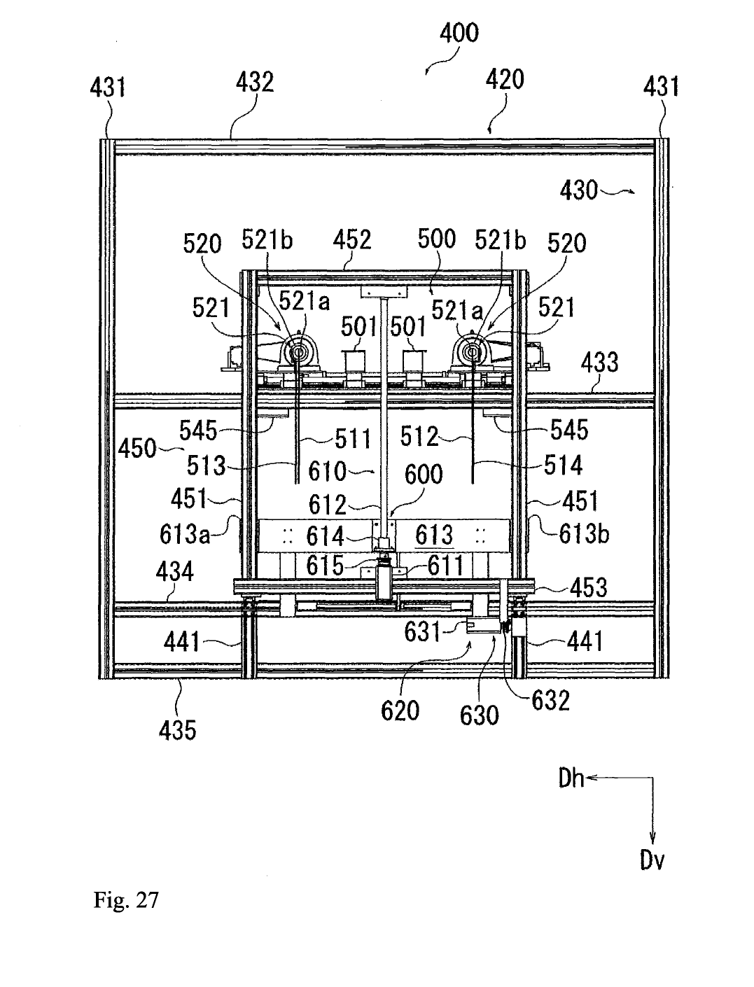

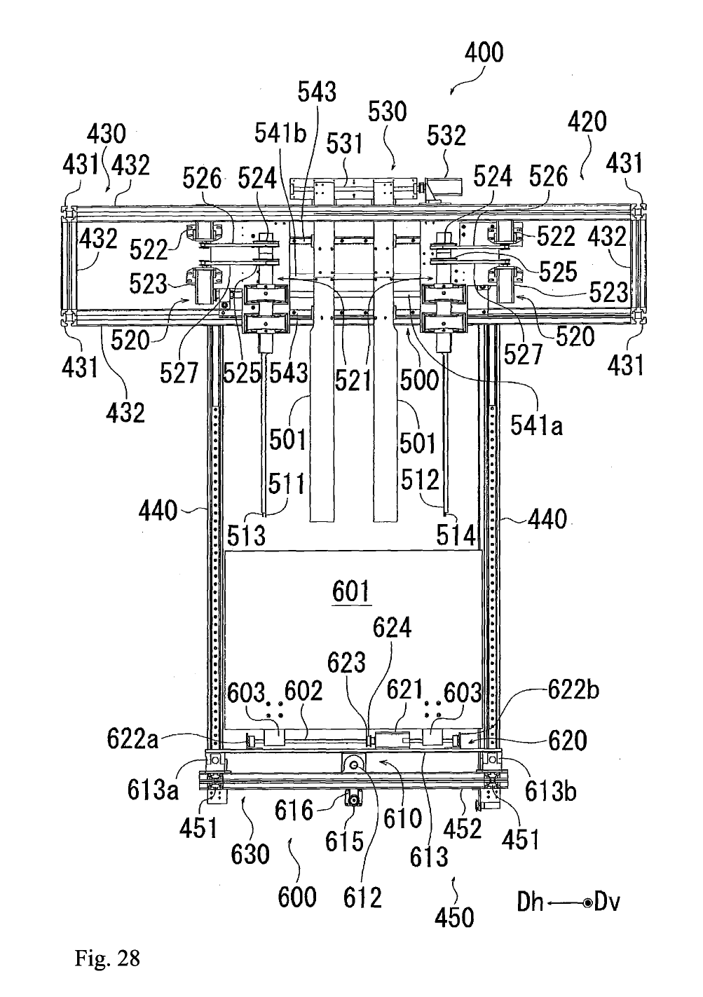

As illustrated in FIGS. 27 and 28, the dual nested shaft rotary mechanisms 520 are a pair of mechanisms disposed in the right-and-left direction. Each dual nested shaft rotary mechanism 520 mainly includes a dual nested shaft 521, an inner shaft rotary motor 522, an outer shaft rotary motor 523, an inner shaft pulley 524, an outer shaft pulley 525, a first pulley belt 526 and a second pulley belt 527.

Each dual nested shaft 521 is formed by an inner shaft 521a and an outer shaft 521b. It should be noted that each inner shaft 521a is a columnar shaft that the folding plate 511/512 is attached to the tip thereof. On the other hand, each outer shaft 521b is a cylindrical shaft that the folding plate 513/514 is attached to the tip thereof. Further, each inner shaft 521a is rotatably inserted into each outer shaft 521b while the base end thereof is partially protruded from each outer shaft 521b.

Each inner shaft pulley 524 is fitted into the base end of each inner shaft 521a.

Each outer shaft pulley 525 is fitted into the base end of each outer shaft 521b.

Each first pulley belt 526 is stretched over a shaft of each inner shaft rotary motor 522 and each inner shaft pulley 524. Each first pulley belt 526 serves to transfer rotary power of each inner shaft rotary motor 522 to each inner shaft 521a for rotating each inner shaft 521a.

Each second pulley belt 527 is stretched over a shaft of each outer shaft rotary motor 523 and each outer shaft pulley 525. Each second pulley belt 527 serves to transfer rotary power of each outer shaft rotary motor 523 to each outer shaft 521b for rotating each outer shaft 521b.

Each inner shaft rotary motor 522 and each outer shaft rotary motor 523 are forwardly and reversely rotatable.

(2-4) Inter-Platen-Plate Distance Adjusting Mechanism

As illustrated in FIG. 28, the inter-platen-plate distance adjusting mechanism 530 mainly includes a first ball screw 531, first nuts (not illustrated in the figures), a first rail member (not illustrated in the figures) and a first ball screw driving motor 532.

The first ball screw 531 is formed by a right-handed thread ball screw portion and a left-handed thread ball screw portion. It should be herein noted that the right-handed thread ball screw portion and the left-handed thread ball screw portion are disposed concentrically to each other. Further, the first ball screw 531 is rotatably fixed to the first rail member while the axis thereof is arranged in parallel to the rail portion (not illustrated in the figures) of the first rail member.

The first nuts are screwed onto the right-handed thread ball screw portion and the left-handed thread ball screw portion of the first ball screw 531, respectively. The first nuts are configured to be slid and moved on the rail portion along the axial direction of the first ball screw 531 in conjunction with driving of the first ball screw driving motor 532. It should be noted in the present exemplary embodiment that the first nuts are configured to be slid and moved in opposite directions due to the structure that the first nuts are respectively screwed onto the right-handed thread ball screw portion and the left-handed thread ball screw portion of the first ball screw 531. In other words, the first nuts are configured to be slid and moved closer to or away from each other. Further, the platen plates 501 are attached to the first nuts. Therefore, the inter-platen-plate distance adjusting mechanism 530 is allowed to adjust the width of the platen plates 501.

The first ball screw driving motor 532 is coupled to an end of the first ball screw 531 while the shaft thereof is arranged along the axis of the first ball screw 531.

(2-5) Folding Plate Sliding Mechanism

A pair of the folding plate sliding mechanisms 540 is disposed correspondingly to the dual nested shaft rotary mechanisms 520 in the right-and-left direction. As illustrated in FIGS. 26 to 28, the folding plate sliding mechanisms 540 mainly include the third ball screws 541a and 541b, third nuts (not illustrated in the figures), third rail members 543, third ball screw driving motors 545, 31^{st} pulleys 546, 32^{nd} pulleys 547 and third pulley belts 548. Further, in the following explanation, the third ball screws with reference numerals of 541a and 541b may be respectively referred to as “a 31^{st} ball screw” and “a 32^{nd} ball screw”.

As illustrated in FIG. 28, two third ball screws 541a and 541b are disposed in roughly parallel to the first ball screw 531.

The third nuts are screwed onto two third ball screws 541a and 541b, respectively. The dual nested shaft rotary mechanisms 520 are attached to the third nuts, respectively.

Each 31^{st} pulley 546 is fitted onto the tip of each third ball screw driving motor 545.

Each 32^{nd} pulley 547 is fitted onto the base end of each third ball screw 541a/541b.

Each third pulley belt 548 is stretched over each 31^{st} pulley 546 and each 32^{nd} pulley 547. Each third pulley belt 548 serves to transfer rotary power of each third ball screw driving motor 545 to each third ball screw 541a/541b through each 31^{st} pulley 546 and each 32^{nd} pulley 547 in order to rotate each third ball screw 541a/541b.

Each third ball screw driving motor 545 is forwardly and reversely rotatable.

(3) Transporting Mechanism

As illustrated in FIGS. 26 to 28, the transporting mechanism 600 mainly includes a pull-out plate 601, a pull-out plate up-and-down transporting mechanism 610, a pull-out plate rotary mechanism 620 and a pull-out plate back-and-forth transporting mechanism 630.

Elements of the transporting mechanism 600 will be hereinafter respectively explained in detail.

(3-1) Pull-Out Plate

The pull-out plate 601 is a roughly rectangular plate member. It should be noted that the pull-out plate 601 includes two protrusions 603 and a rotary bar 602 as illustrated in FIG. 28. The protrusions 603 are backwardly extended, while the rotary bar 602 is fixed to the protrusions 603. Further, the 21^{st} pulley (not illustrated in the figure) is attached to the rotary bar 602.

(3-2) Pull-Out Plate Up-and-Down Transporting Mechanism

As illustrated in FIGS. 26 to 28, the pull-out plate up-and-down transporting mechanism 610 mainly includes a fourth ball screw 612, a fourth ball screw driving motor 611, a fourth nut 614, an attachment plate 613, an 11^{th} pulley 615, a 12^{th} pulley belt 616 and a 12^{th} pulley 617.

As illustrated in FIGS. 26 to 28, the fourth ball screw 612 is disposed while the axis thereof is arranged along the vertical direction Dv.

The fourth nut 614 is screwed onto the fourth ball screw 612. The fourth nut 614 is configured to be moved along the axial direction of the fourth ball screw 612 in conjunction with driving of the fourth ball screw driving motor 611.

The fourth nut 614 is fixed to the attachment plate 613. Further, the attachment plate 613 includes rail portions 613a and 613b on the both ends of the attachment plate 613. It should be noted that the rail portions 613a and 613b are fitted onto the second pillar members 451 of the rear frame 450. Therefore, the attachment plate 613 is configured to be moved up and down along the second pillar members 451 when the fourth nut 614 is moved up and down along the fourth ball screw 612. Further, the pull-out plate 601 is attached to the front face of the attachment plate 613 through the pull-out plate rotary mechanism 620.

As illustrated in FIGS. 26 to 28, the 11^{th} pulley 615 is attached to the shaft of the fourth ball screw driving motor 611.

As illustrated in FIG. 26, the 12^{th} pulley 617 is attached to the bottom end of the fourth ball screw 612.

The 12^{th} pulley belt 616 is stretched over the 11^{th} pulley 615 and the 12^{th} pulley 617.

In other words, in conjunction with driving of the fourth ball screw driving motor 611, rotational power of the fourth ball screw driving motor 611 is transferred to the fourth ball screw 612 through the 11^{th} pulley 615, the 12^{th} pulley belt 616 and the 12^{th} pulley 617. As a result, the fourth ball screw 612 is rotated about the axis thereof. The attachment plate 613 is consequently moved up and down along the second pillar members 451.

(3-3) Pull-Out Plate Rotary Mechanism

As illustrated in FIG. 28, the pull-out plate rotary mechanism 620 mainly includes rotary bar support bodies 622a and 622b, a 22^{nd} pulley 623, a 22^{nd} pulley belt 624 and a rotary bar driving motor 621.

The rotary bar support bodies 622a and 622b support the rotary bar 602 disposed rearwards of the pull-out plate 601 for allowing it to rotate.

The 22^{nd} pulley 623 is attached to the shaft of the rotary bar driving motor 621.

The 22^{nd} pulley belt 624 is stretched over the 22^{nd} pulley 623 and the 21^{st} pulley attached to the rotary bar 602.

In short, in conjunction with driving of the rotary bar driving motor 621, rotational power of the rotary bar driving motor 621 is transferred to the rotary bar 602 through the 22^{nd} pulley 623, the 22^{nd} pulley belt 624 and the 21^{st} pulley. As a result, the pull-out plate 601 is upwardly pivoted and lifted up.

(3-4) Pull-Out Plate Back-and-Forth Transporting Mechanism

The pull-out plate back-and-forth transporting mechanism 630 is disposed for implementing back-and-forth movement of the transporting mechanism 600. As illustrated in FIG. 27, the pull-out plate back-and-forth transporting mechanism 630 mainly includes a back-and-forth driving motor 631, a wire (not illustrated in the figure) and a wire support portion 632.

In conjunction with driving of the back-and-forth driving motor 631, the wire is configured to be moved along the wire support portion 632. In conjunction with the wire movement, the transporting mechanism 600 is configured to be moved back and forth.

<Actions of Folding Device>

Actions of the folding device 400 according to the second exemplary embodiment of the present invention will be hereinafter explained with reference to the drawings.

In the folding device 400 according to the second exemplary embodiment of the present invention, the folding mechanism 500 is firstly set to be in a state illustrated in FIG. 27. In other. words, the folding device 400 is set to be in a state (initial state) that the folding plates 211 to 214 are hung down roughly in the vertical direction in a front view. In the state, a folding object (e.g., fabric) is put on the platen plates 501. It should be noted that the width between the platen plates 501 is adjusted by the inter-platen-plate distance adjusting mechanism 530 as described above.

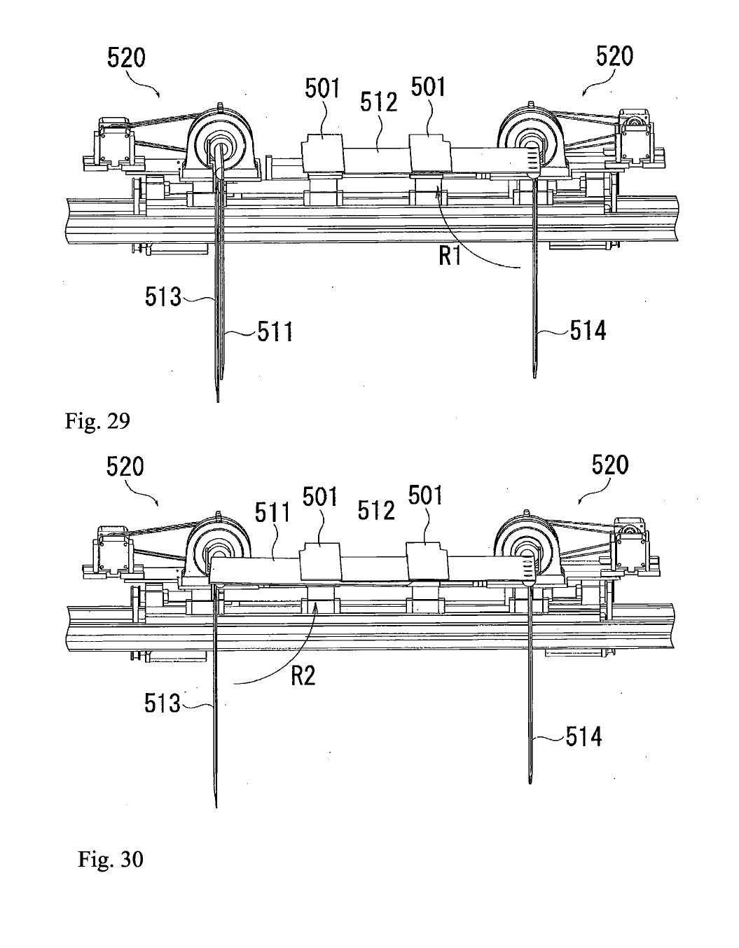

Next, the inner shaft rotary motor 522 of the dual nested shaft rotary mechanism 520 rotates the second folding plate 512 leftward (clockwisedly) at an angle of roughly 90 degrees in FIG. 29 (see an arrow R1 in FIG. 29). The second folding plate 512 is thereby set to be in a state illustrated in FIG. 29 (a second state). In other words, the second folding plate 512 is disposed adjacent to the bottom face of the platen plate 501. It should be herein noted that a part of the folding object, hung down from the right side of the platen plates 501 in FIG. 29, is interposed and folded between the second folding plate 512 and the platen plate 501.

Next, the inner shaft rotary motor 522 of the dual nested shaft rotary mechanism 520 rotates the first folding plate 511 rightward (counterclockwisedly) at an angle of roughly 90 degrees in FIG. 30 (see an arrow R2 in FIG. 30). The first folding plate 511 is thereby set to be in a state illustrated in FIG. 30 (a third state). In other words, the first folding plate 511 is disposed adjacent to the bottom face of the second folding plate 512. It should be herein noted that a part of the folding object, hung down from the left side of the platen plates 501 in FIG. 30, is interposed and folded between the first folding plate 511 and the second folding plate 512.

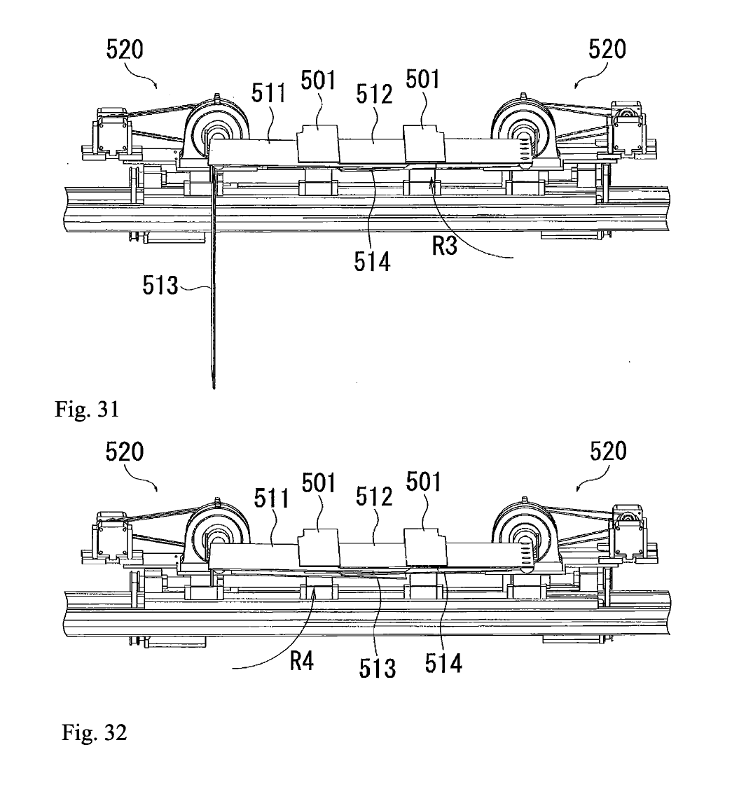

Next, the outer shaft rotary motor 523 of the dual nested shaft rotary mechanism 520 rotates the fourth folding plate 514 leftward (clockwisedly) at an angle of roughly 90 degrees in FIG. 31 (see an arrow R3 in FIG. 31). The fourth folding plate 514 is thereby set to be in a state illustrated in FIG. 31 (a fourth state). In other words, the fourth folding plate 514 is disposed adjacent to the bottom face of the first folding plate 511. It should be herein noted that a part of the folding object, hung down from the right side of the first folding plates 511 in FIG. 31, is interposed and folded between the fourth folding plate 514 and the first folding plate 511.

Next, the outer shaft rotary motor 523 of the dual nested shaft rotary mechanism 520 rotates the third folding plate 513 rightward (counterclockwisedly) at an angle of roughly 90 degrees in FIG. 32 (see an arrow R4 in FIG. 32). The third folding plate 513 is thereby set to be in a state illustrated in FIG. 32 (a fifth state). In other words, the third folding plate 513 is disposed adjacent to the bottom face of the fourth folding plate 514. It should be herein noted that a part of the folding object, hung down from the left side of the fourth folding plate 514 in FIG. 32, is interposed and folded between the third folding plate 513 and the fourth folding plate 514.

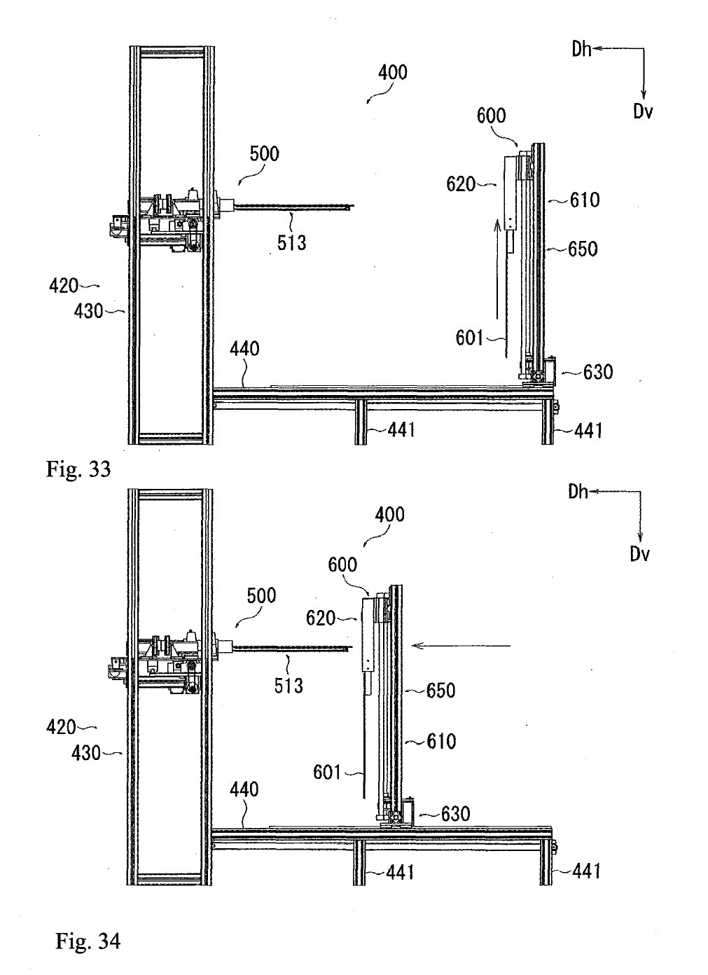

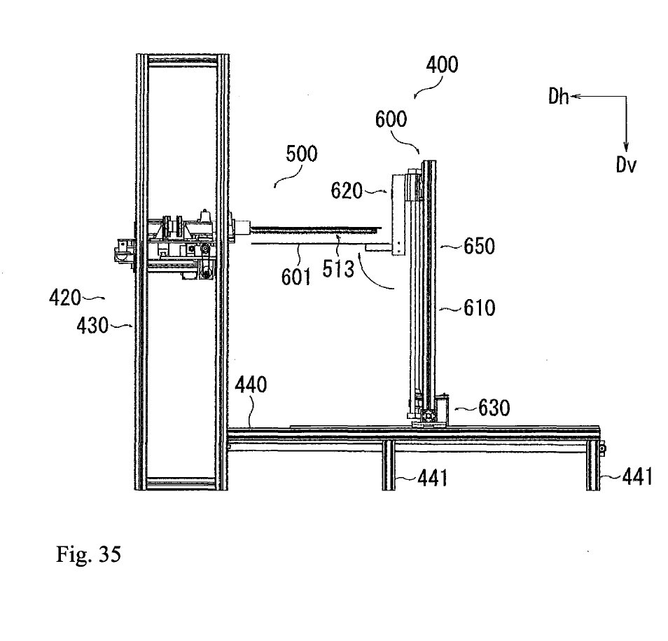

Next, the pull-out plate up-and-down transporting mechanism 610 lifts up the pull-out plate 601 to a predetermined height as illustrated in FIG. 33 (a second state). The pull-out plate back-and-forth transporting mechanism 630 then forwardly moves the pull-out plate 601 to a predetermined position as illustrated in FIG. 34 (a third state). It should be noted that the pull-out plate 601 is herein positioned while the plate face thereof is arranged along the vertical direction Dv. The pull-out plate rotary mechanism 620 then pivots the pull-out plate 601 to a position where the pull-out plate 601 is disposed roughly in parallel to the third folding plate 513 as illustrated in FIG. 35 (a fourth state).

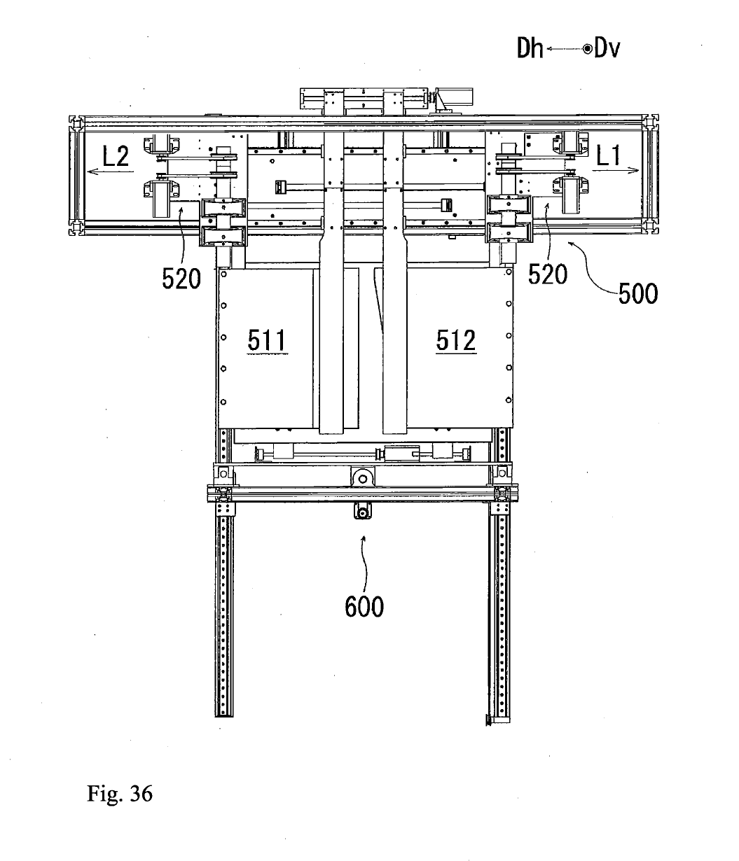

Subsequently, the right-side folding plate sliding mechanism 540 rightwardly slides and moves the right-side dual nested shaft rotary mechanism 520 in FIG. 32, while the left-side folding plate sliding mechanism 540 leftwardly slides and moves the left-side dual nested shaft rotary mechanisms 520 in FIG. 32 (see arrows L1 and L2 in FIG. 36). The folding device 400 is thereby set to be in a state illustrated in FIG. 36 (a sixth state). The folding plates 511 to 514 are herein removed from the folding object, and the folding object can be easily pulled out by means of the pull-out plate 601.

Finally, the pull-out plate 601 is lifted down by the pull-out plate up-and-down transporting mechanism 610, while being backwardly moved by the pull-out plate back-and-forth transporting mechanism 630. The pull-out plate 601 is thereby set to be in a state illustrated in FIG. 26.

It should be noted that the aforementioned actions of the folding device 400 are configured to be executed by a control device (not illustrated in the figures).

<Features of Folding Device>

(1)

In the folding device 400 according to the present exemplary embodiment, a part of the folding object, hung down from the platen plates 501, is folded by the flip-up-to-the-bottom type folding mechanism 500. According to the folding device 400, the folding object is thus hardly damaged in performing the folding action.

(2)

In the folding device 400 according to the present exemplary embodiment, a folding object is folded, and then, the folding plates 511 to 514 inserted within the folding object are slid and moved away from the platen plates 501 in the right-and-left direction by means of the folding plate sliding mechanisms 540. The folding members 511 to 514 are removed out of the folding object. Therefore, the folding object in a folded state can be removed with little chances of damage after completion of the folding action in the folding device 400.

<Modifications>

(A)

In the folding device 400 according to the aforementioned exemplary embodiment, the inter-platen-plate distance adjusting mechanism 530 can adjust the width between the platen plates 501. In such a case that folding objects with the same size are prepared, the inter-platen-plate distance adjusting mechanism 530 may be removed and only a single platen plate may be used.

(B)

In the folding device 400 according to the aforementioned exemplary embodiment, four folding plates 511 to 514 are provided. However, the number of the folding plates 511 to 514 is not particularly limited, and may be increased or reduced in accordance with the shape or size of a folding object. It should be noted that the configuration can be implemented using a multiple nested shaft rotary mechanism instead of the dual nested shaft rotary mechanisms 520.

(C)

The folding plates 511 to 514 may be frame-shaped members or stick-shaped members, although not particularly described in the aforementioned exemplary embodiment. When the folding plates 511 to 514 are herein the stick-shaped members, it is required to respectively dispose the newly set stick-shaped members in positions corresponding to those of the bottom sides of the folding plates 511 to 514 in the initial state.

(D)

In the folding device 400 according to the aforementioned exemplary embodiment, driving of pulleys, pulley belts, a motor direct connection structure and etc. are utilized in the folding mechanism 500 and the transporting mechanism 600. However, utilization of driving of the elements can be arbitrarily selected without departing from the scope of the present invention.

(E)

In the aforementioned exemplary embodiment, the folding device 400 has been employed, which includes the folding plates 511 to 514 configured to be flipped up from the lower positions towards the bottom faces of the platen plates 501. However, a type of a folding device may be employed, which includes folding plates configured to be flipped up towards the top face of the platen plate. In this case, the folding plates are required to be disposed adjacent to the platen plates. Further, a folding object is required to be put on the platen plates 501 while covering the folding plate in the initial state.

(F)

Although not particularly described in the aforementioned exemplary embodiment, the inner shaft rotary motors 522 and the outer shaft rotary motors 523 may be slightly rotated in the reverse direction for increasing the interval between the platen plate 501 and the second folding plate 512 and the intervals among the folding plates 511 to 514 after the folding mechanism 500 is set to be in the fifth state. With the configuration, it is possible to easily pull out the folding plates 511 to 514 from a folding object, and simultaneously, avoid applying excessive friction to the folding object when the folding plate sliding mechanisms 540 remove the folding plates 511 to 514 from the folding object.

(G)

The inter-platen-plate distance adjusting mechanism 530 may be configured to reduce the distance between the platen plates 501 before the folding object is pulled out by the pull-out plate 601 after the folding mechanism 500 is set to be in the fifth state, although not particularly described for the folding device 400 according to the aforementioned exemplary embodiment. With the configuration, tension applied to a folding object by the platen plates 501 is relieved and the folding object can be easily pulled out. Further, it is possible to prevent the folding object from getting stuck with the platen plates 501 and being thereby damaged.

(H)

A platen plate tip position moving mechanism (not illustrated in the figures) may be further provided for moving back and forth the position of the longitudinally rear frame side tips of the platen plates 501 along the longitudinal direction of the platen plates 501, although not particularly described for the folding device 400 according to the aforementioned exemplary embodiment. The platen plate tip position moving mechanism is preferably configured to move the tips of the platen plates 501 at least from (i) the tip positions of the folding plates 511 to 514 to (ii) positions shifted from the tip positions of the folding plates 511 to 514 by a length of several centimeters or tens of centimeters. It should be noted that the platen plate tip position moving mechanism of this type can be structured using a ball screw mechanism. For example, the platen plates 501 may be configured to be extended and contracted by longitudinally splitting the platen platens 501 into two pieces and then coupling the split platen plate pieces by a ball screw mechanism disposed while the rotational axis thereof is arranged along the longitudinal direction of the split platen plate pieces. Further, the ball screw mechanism may be configured to move back and forth the inter-platen-plate distance adjusting mechanism 530 along the longitudinal direction of the platen plates 501.

In the folding device thus including the platen plate tip position moving mechanism, a folding object is put on the platen plates 501 while the tips of the platen plates 501 are protruded from the tip positions of the folding plates 511 to 514. Then, the inner shaft rotary motor 522 of the dual nested shaft rotary mechanism 520 rotates the second folding plate 512 leftward (clockwisedly) at an angle of roughly 90 degrees in FIG. 29 (see the arrow R1 in FIG. 29), and subsequently, the inner shaft rotary motor 522 of the dual nested shaft rotary mechanism 520 rotates the first folding plate 511 rightward (counterclockwisedly) at an angle of roughly 90 degrees in FIG. 30 (see the arrow R2 in FIG. 30). Subsequently, the platen plate tip position moving mechanism is configured to backwardly move the tips of the platen plates 501 to the tip positions of the folding plates 511 to 514. It should be noted that the backward movement may be executed at the timing when the outer shaft rotary motor 523 of the dual nested shaft rotary mechanism 520 rotates the fourth folding plate 514 leftward (clockwisedly) at an angle of roughly 90 degrees in FIG. 31 (see the arrow R3 in FIG. 31), or alternatively, at the timing when the outer shaft rotary motor 523 of the dual nested shaft rotary mechanisms 520 rotates the third folding plate 513 rightward (counterclockwisedly) at an angle of roughly 90 degrees in FIG. 32 (see the arrow R4 in FIG. 32).

(I)

In the folding device 400 according to the aforementioned exemplary embodiment, the right-side dual nested shaft rotary mechanism 520 in FIG. 32 is rightwardly slid and moved by means of the corresponding one of the folding plate sliding mechanisms 540, while the left-side dual nested shaft rotary mechanism 520 in FIG. 32 is leftwardly slid and moved by means of another corresponding one of the folding plate sliding mechanism 540 (see the arrows L1 and L2 in FIG. 36). Accordingly, the folding device 400 is set to be in the state illustrated in FIG. 36 (the sixth state). However, under the condition that one of the dual nested shaft rotary mechanisms 520 (hereinafter referred to as “a stationary dual nested shaft rotary mechanism”) is fixed and the other of the dual nested shaft rotary mechanisms 520 (hereinafter referred to as “a movable dual nested shaft rotary mechanism”) is moved away from the platen plates 501 while the platen plates 501 are moved away from the stationary dual nested shaft rotary mechanisms 520, the platen plates 501 and the movable dual nested shaft rotary mechanisms 520 may be configured to be rightwardly or leftwardly slid and moved. In this case, a platen plate slide moving mechanism is required for rightwardly or leftwardly sliding and moving the inter-platen-plate distance adjusting mechanism 530 along the horizontal direction Dh. Thus configured platen plate slide moving mechanism can be implemented using a ball screw mechanism. For example, the inter-platen-plate distance adjusting mechanism 530 may be configured to be rightwardly or leftwardly slid and moved along the horizontal direction Dh by means of the ball screw mechanism.

(J)

In the folding device 400 according to the aforementioned exemplary embodiment, when the folding mechanism 500 folds a folding object, the pull-out plate up-and-down transporting mechanism 610 is configured to lift up the pull-out plate 601 to a predetermined height (the second state) as illustrated in FIG. 33. The pull-out plate back-and-forth transporting mechanism 630 is then configured to forwardly move the pull-out plate 601 to a predetermined position (the third state) as illustrated in FIG. 34. Further, the pull-out plate rotary mechanism 620 is configured to rotate the pull-out plate 601 to a position where the pull-out plate 601 is arranged roughly in parallel to the third folding plate 213 (the fourth state) as illustrated in FIG. 35. However, after the folding mechanism 500 folds the folding object, the pull-out plate up-and-down transporting mechanism 610 may be firstly configured to lift up the pull-out plate 601 to a predetermined height. Next, the pull-out plate rotary mechanism 620 may be configured to rotate the pull-out plate 601 to a roughly horizontal position. Thereafter, the pull-out plate back-and-forth transporting mechanism 630 may be configured to forwardly move the pull-out plate 601 to a predetermined position.

(K)

In the folding device 400 according to the aforementioned exemplary embodiment, the action of the pull-out plate 601 is controlled by the transporting mechanism 600. However, the action of the pull-out plate 601 may be controlled by either a robot-hand attached multi-axis robot arm or a robot-hand attached Cartesian coordinate robot. It should be noted that the number of the robot-hand attached multi-axis robot arms herein provided may be one, or alternatively, two or more. When the robot-hand attached Cartesian coordinate robot is herein used, the number of robot hands attached thereto may be one, or alternatively, two or more. In this case, the pull-out plate is preferably provided with a portion (or portions) (hereinafter referred to as “a clamped portion (or clamped portions)”) to be clamped by the robot hand (or robot hands). For example, the clamped portion may be either a sidewall upwardly extended from the rear end (or the vicinity of the rear end) of the pull-out plate or a sidewall upwardly extended from the lateral end (or the vicinity of the lateral end) of the pull-out plate. In the latter case, the pull-out plate may include either the sidewall on either of the lateral ends thereof (or the vicinity of either of the lateral ends thereof) or the sidewalls on the both lateral ends thereof (or the vicinity of the both lateral ends thereof). Further, the action of the pull-out plate may be configured to be identical to that of the pull-out plate 601 in the folding device 400 according to the aforementioned exemplary embodiment, or alternatively, identical to that of the pull-out plate 601 described in the aforementioned exemplary modification (J).

(L)

A folding object Storage box is preferably disposed beside the folding mechanism 500, although not particularly described in the aforementioned exemplary embodiment. It should be noted that the folding object storage box is preferably at least opened towards the rear frame of the folding device 400 in the back-and-forth direction and is further preferably opened upwards. In this case, the folding object, folded by the folding device 400, is configured to be stored in the folding object storage box as follows.

First, the pull-out plate, putting a folding object thereon, is moved backwards so that the tip of the pull-out plate is positioned rearwards of the storage opening of the folding object storage box in a side view. Next, the pull-out plate is moved in both the up-and-down direction and the right-and-left direction so that the pull-out plate is opposed to the storage opening of the folding object storage box. Subsequently, the pull-out plate is forwardly moved towards the folding object storage box and is inserted into the storage space of the folding object storage box. To implement a series of these actions of the pull-out plate, it is required to preliminarily set a coordinate in an action program. Next, a folding object stopper is lifted down towards either the folding object or the rear end (opposite to the tip) of the pull-out plate. It should be noted that the folding object stopper may be of a lever type, or alternatively, of a shutter type. The pull-out plate is then moved backwards while the folding object stopper is completely lifted down. The folding object is accordingly stored in the storage space of the folding object storage box.

To implement the actions of the pull-out plate, the transporting mechanism 600 according to the aforementioned exemplary embodiment further requires a second pull-out plate back-and-forth transporting mechanism and a pull-out plate right-and-left transporting mechanism. The second pull-out plate back-and-forth transporting mechanism is disposed in parallel to the pull-out plate back-and-forth transporting mechanism 630, whereas the pull-out plate right-and-left transporting mechanism implements movement of the pull-out plate 601 between the pull-out plate back-and-forth transporting mechanism 630 and the second pull-out plate back-and-forth transporting mechanism. When a pull-out plate rotary mechanism is herein further provided, the pull-out plate 601 can be more flexibly moved. In this case, a method of disposing the folding object storage box is not particularly limited as long as the folding object storage box is disposed within the operative range of the transporting mechanism. It should be noted that any person skilled in the art of the present invention can easily embody the structure and configuration. Therefore, detailed explanation thereof will be hereinafter omitted.

Further, the aforementioned action of the pull-out plate can be implemented utilizing either the robot-hand attached multi-axis robot arm or the robot hand attached Cartesian coordinate type robot according to the aforementioned exemplary modification (K) instead of the transporting mechanism 600 according to the aforementioned exemplary embodiment. In this case, a method of disposing the folding object storage box is not particularly limited as long as the folding object storage box is disposed within the operative range of either the robot-hand attached multi-axis robot arm or the robot-hand attached Cartesian coordinate type robot.

(M)

The aforementioned exemplary modifications (A) to (L) may be used in arbitrarily combinations.

For example, the actions of the pull-out plate may be configured as follows.

First, the clamped portion of the pull-out plate disposed below the folding mechanism 500 is clamped in two positions by means of either two robot-hand attached multi-axis robot arms or two robot hands of two robot-hand attached Cartesian coordinate type robots (hereinafter simply referred to as “robots”) (see the aforementioned exemplary modification (K)). Next, the robots move the pull-out plate to the rearward of the folding mechanism 500 (see the aforementioned exemplary modification (L)). Subsequently, the robots forwardly move the pull-out plate towards the folding object such as a shirt that the both sleeves thereof have been already folded and only the hems thereof are hung down (see the aforementioned exemplary modifications (J) and (K)). As a result, the hems are folded by the pull-out plate. Next, the inner shaft rotary motors 522 and the outer shaft rotary motors 523 are slightly rotated in the reverse direction. Thus, the interval between the platen plate 501 and the second folding plate 512 and the interval among the folding plates 511 to 514 are extended (see the aforementioned exemplary modification (F)). The movable dual nested shaft rotary mechanism 520 is then slid and moved away from the platen plates 501 (see the aforementioned exemplary modification (I)). Next, the platen plates 501 are slid and moved away from the stationary dual nested shaft rotary mechanism 520, and the pull-out plate is also slid and moved by the robots in accordance with the slide movement of the platen plates 501 (see the aforementioned exemplary modification (I)). Subsequently, the robots backwardly move the pull-out plate. As a result, the folded shirt or the like is removed from the platen plates 501 and put on the pull-out plate. Further, the shirt or the like is stored in the folding object storage box as described in the aforementioned exemplary modification (L).

### INDUSTRIAL APPLICABILITY

The folding device of the present invention is characterized in that a folding object (e.g., a fabric product) in a folded state can be taken out with little chances of damage not only during execution of a folding action but also after completion of the folding action. Therefore, the folding device of the present invention is useful, for instance, as a home-use folding device.

1. A folding device, comprising:
a platen member configured to receive a folding object thereon and to allow an extended part of the folding object to extend from at least one of right and left sides of the platen member;
at least one folding member;
a folding member mechanism configured to move the folding member towards the platen member for folding the extended part of the folding object; and
a horizontal slide moving mechanism configured to slide and move at least one of the platen member and the folding member for separating the platen member and the folding member along a horizontal direction.

2. The folding device recited in claim 1, wherein
the platen member is formed by a pair of members opposed to each other, and
further comprising a width adjusting mechanism configured to move the pair of members either closer to each other or away from each other.

3. The folding device recited in claim 1, wherein
the folding member is disposed below the platen member in an initial state, and
the folding member mechanism includes a moving mechanism configured to either slide and move or rotate to move the folding member towards the platen member; and a rotary mechanism configured to rotate the platen member and the moving mechanism.

4. The folding device recited in claim 1, wherein
the folding member mechanism is configured to rotate the folding member under the platen member so as to be substantially parallel with the platen member.

5. The folding device recited in claim 1, wherein
the folding member mechanism is configured to rotate the folding member above the platen member so as to be substantially parallel with the platen member.

6. A folding method, comprising:
placing a folding object on a platen member for allowing an extended part of the folding object to be extended from at least one of right and left sides of the platen member;
moving a folding member towards the platen member for folding the extended part of the folding object; and
sliding and moving at least one of the platen member and the folding member at least one of rightward and leftward for separating the platen member and the folding member along a horizontal direction in order to pull the folding member out of the folding object in a folded state.

7. The folding method recited in claim 6, further comprising:
returning the folding member to be separated away from the platen member along a direction perpendicular to the horizontal direction.

8. The folding method recited in claim 6, wherein
the platen member is formed by a pair of members opposed to each other, and further comprising
moving the pair of members closer to each other.

9. The folding device recited in claim 1, further comprising
a pull out plate configured to, after the folding object is folded, move below the platen plate, be substantially parallel to the platen plate, and pull the folding object out of the platen plate.

10. The folding device recited in claim 2, wherein
the folding member is disposed below the platen member in an initial state, and the folding member mechanism includes a moving mechanism configured to either slide and move or rotate to move the folding member towards the platen member; and a rotary mechanism configured to rotate the platen member and the moving mechanism.

11. The folding device recited in claim 2, wherein
the folding member mechanism is configured to rotate the folding member under the platen member so as to be substantially parallel with the platen member.

12. The folding device recited in claim 2, wherein
the folding member mechanism is configured to rotate the folding member above the platen member so as to be substantially parallel with the platen member.

13. The folding device recited in claim 2, further comprising
a pull out plate configured to, after the folding object is folded, move below the platen plate, be substantially parallel to the platen plate, and pull the folding object out of the platen plate.

14. The folding device recited in claim 3, further comprising
a pull out plate configured to, after the folding object is folded, move below the platen plate, be substantially parallel to the platen plate, and pull the folding object out of the platen plate.

15. The folding device recited in claim 4, further comprising
a pull out plate configured to, after the folding object is folded, move below the platen plate, be substantially parallel to the platen plate, and pull the folding object out of the platen plate.

16. The folding device recited in claim 5, further comprising
a pull out plate configured to, after the folding object is folded, move below the platen plate, be substantially parallel to the platen plate, and pull the folding object out of the platen plate.

17. The folding device recited in claim 10, further comprising
a pull out plate configured to, after the folding object is folded, move below the platen plate, be substantially parallel to the platen plate, and pull the folding object out of the platen plate.

18. The folding device recited in claim 11, further comprising
a pull out plate configured to, after the folding object is folded, move below the platen plate, be substantially parallel to the platen plate, and pull the folding object out of the platen plate.

19. The folding device recited in claim 12, further comprising
a pull out plate configured to, after the folding object is folded, move below the platen plate, be substantially parallel to the platen plate, and pull the folding object out of the platen plate.
